(19) United States
(12) Patent Application Publication
(10) Pub. No.: US 2024/0430040 A1
(43) Pub. Date: Dec. 26, 2024

(54) Terminal Devices, Network Devices, and Methods Thereof

(71) Applicant: TELEFONAKTIEBOLAGET LM ERICSSON (PUBL), Stockholm (SE)

(72) Inventor: Min Wang, Luleå (SE)

(21) Appl. No.: 18/693,830

(22) PCT Filed: Sep. 22, 2022
(86) PCT No.: PCT/EP2022/076455

§ 371 Date: Mar. 20, 2024

Related U.S. Application Data
(60) Provisional application No. 63/247,480, filed on Sep. 23, 2021.

(51) Int. Cl. H04L 1/1812; H04W 72/25; H04W 74/0808

(52) U.S. Cl. CPC H04L 1/1812; H04W 72/25; H04W 74/0808

(57) ABSTRACT

The present disclosure provides a method for Side Link (SL) transmission on an Unlicensed band (SL-U), performed by a first terminal device. The method includes: receiving transmission resources for the SL-U transmission allocated by a network device to the first terminal device; performing the SL-U transmission on the transmission resources to a second terminal device; obtaining a Hybrid Automatic Repeat Request, HARQ, acknowledgment associated with the SL-U transmission; configuring a resource for the HARQ acknowledgment; and transmitting the HARQ acknowledgement to the network device on the configured resource, wherein the configured resource is time compensated for Listen Before Talk (LBT) delays occurring during the SL-U transmission and/or during a transmission of the HARQ acknowledgement.

### TECHNICAL FIELD

The present disclosure relates to wireless communication, and more particularly, to terminal devices, network devices, and methods thereof related to Side Link (SL) transmission on an Unlicensed band (SL-U).

### BACKGROUND

Next generation systems are expected to support a wide range of use cases with varying requirements ranging from fully mobile devices to stationary internet of things (IoT) or fixed wireless broadband devices. The traffic pattern associated with many use cases is expected to consist of short or long bursts of data traffic with varying length of waiting period in between (here called inactive state). In new radio (NR), both license assisted access and standalone unlicensed operation are to be supported in the third generation partnership project (3GPP). Hence, the procedure of physical random access channel (PRACH) transmission and/or scheduling request (SR) transmission in an unlicensed spectrum is to be investigated in 3GPP.

For next 3GPP releases, sidelink (SL) transmission on the unlicensed spectrum (SL-U) is a new technology which is attracting strong interest from companies. However, there are still some issues that need to be addressed.

### SUMMARY

As noted above, there are still some issues that need to be addressed in relation to using sidelink (SL) transmission on an unlicensed spectrum (SL-U) and one of these issues is that delays can lead to resource wastage.

In more detail, in order to support sidelink (SL) transmission on an unlicensed spectrum (SL-U), a similar channel access mechanism as in New Radio (NR) supported on an unlicensed spectrum (NR-U) needs to be introduced for SL-U. With a channel access mechanism, an SL capable user equipment (UE) may need to perform an Listen Before Talk (LBT) operation prior to an SL transmission. An SL transmission on an unlicensed band needs to support resource allocation ‘Mode 1’ (which will be detailed later), since the Next Generation Node B (gNB) is able to provide the flexible resource allocation for SL transmissions. In existing 3GPP releases, the gNB assigns SL grants to an SL UE in the Downlink Control Information (DCI), which may also carry the Physical Uplink control Channel (PUCCH) resources where the SL UE can forward a SL Hybrid Automatic Repeat Request (HARQ) acknowledgement received from the peer UE to the gNB using those PUCCH resources.

However, in the case of SL transmissions on an unlicensed band, an SL HARQ acknowledgement from the peer UE may be subject to LBT failures. In this case, the SL HARQ acknowledgement may be delayed by LBT failures, so that misses the PUCCH resources assigned by the gNB. In such a case, the gNB is not able to receive the SL HARQ acknowledgement for the SL UE. The gNB may even interpret that the SL transmission has failed so that the gNB may decide to assign resources to the SL UE for retransmissions even if the SL transmission has been successfully received by the peer UE. This may lead to resource wastage.

Therefore, it is an object of the present disclosure to obviate or eliminate at least some of the above-described issues associated with existing techniques and provide corresponding solutions for SL transmissions on an unlicensed band. More specifically, it is an object of the present disclosure to provide terminal devices, network devices, and methods therein, enabling the terminal devices to timely provide HARQ acknowledgement associated with the SL-U transmission to the network devices.

According to a first aspect of the present disclosure, a method for SL transmission on an Unlicensed band (SL-U), performed by a first terminal device is provided. The method includes: receiving transmission resources for SL-U transmission allocated by a network device to the first terminal device; performing the SL-U transmission on the transmission resources to a second terminal device; obtaining a HARQ acknowledgment associated with the SL-U transmission; configuring a resource for the HARQ acknowledgment; and transmitting the HARQ acknowledgement to the network device on the configured resource, wherein the configured resource is time compensated for LBT delays occurring during the SL-U transmission and/or during a transmission of the HARQ acknowledgement.

In an exemplary embodiment, configuring a resource for the HARQ acknowledgement may comprise: configuring a resource for the HARQ acknowledgement as one or more resources allocated by the network device to the first terminal device.

In an exemplary embodiment, the one or more resources allocated by the network device to the first terminal device may comprise one or more of:
one or more resources allocated by the network device to the first terminal device before receiving the transmission resources allocated to the first terminal device;
one or more resources allocated by the network device to the first terminal device upon receiving the transmission resources allocated to the first terminal device; and
one or more resources allocated by the network device to the first terminal device after receiving the transmission resources allocated to the first terminal device.

In an exemplary embodiment, the one or more resources allocated by the network device to the first terminal device after receiving the transmission resources allocated to the first terminal device may be allocated by the network device in response to a request transmitted from the first terminal device to the network device.

In an exemplary embodiment, configuring a resource for the HARQ acknowledgement may comprise one or more of:
finding available resource in allocated resources for transmitting the HARQ acknowledgement,
in response to finding no available resource, transmitting a request to the network device, and
receiving one or more resources allocated by the network device to the first terminal device in response to the request.

In an exemplary embodiment, the request may be a Scheduling Request (SR) or a random access preamble for triggering a Random Access Channel (RACH) procedure.

In an exemplary embodiment, the configured resource may be one or more or a combination of the following:
one or more Physical Uplink control Channel (PUCCH) resources; and
one or more Physical Uplink Shared Channel (PUSCH) resources.

In an exemplary embodiment, the one or more resources allocated by the network device to the first terminal device may comprise resources that are spread in the time domain.

In an exemplary embodiment, a set of resources may be pre-configured from the network device to the first terminal device, and the one or more resources allocated by the network device to the first terminal device may comprise resources that are indicated by indices of resources in the set of resources.

In an exemplary embodiment, the one or more resources allocated by the network device to the first terminal device may be indicated from the network device using one of the following signaling:
Radio Resource Control (RRC) signaling;
Medium Access Control (MAC) Control Element (CE); and
L1 signaling.

In an exemplary embodiment, configuring a resource for the HARQ acknowledgement as one or more resources allocated by the network device to the first terminal device may comprise:
if an UL grant is available at the first terminal device, using a Physical Uplink Shared Channel (PUSCH) resource of the UL grant as the configured resource.

In an exemplary embodiment, using a PUSCH resource of the UL grant as the configured resource may comprise:
mapping the HARQ acknowledgement on the PUSCH resource if there is neither any Medium Access Control (MAC) Service Data Unit (SDU) nor any MAC Control Element (MAC CE) to be transmitted on the PUSCH resource; or
multiplexing the SL HARQ acknowledgement and a MAC Service Data Unit (MAC SDU) or a MAC CE on the PUSCH resource if there is such MAC SDU or MAC CE to be transmitted on the PUSCH resource.

In an exemplary embodiment, obtaining the HARQ acknowledgment associated with the SL-U transmission may comprise:
receiving the HARQ acknowledgment from the second terminal device.

In an exemplary embodiment, obtaining the HARQ acknowledgment associated with the SL-U transmission may comprise:
generating the HARQ acknowledgment if no HARQ acknowledgement is received for a predefined period.

In an exemplary embodiment, generating the HARQ acknowledgment may comprise:
generating a positive HARQ acknowledgment as the HARQ acknowledgment if no transmission resources for SL-U retransmission are required; and
generating a negative HARQ acknowledgment as the HARQ acknowledgment if transmission resources for SL-U retransmission are required.

In an exemplary embodiment, generating the HARQ acknowledgment if no HARQ acknowledgement is received for a predefined period may comprise:
starting a timer after the starting of the SL-U transmission;
stopping the timer when receiving the HARQ acknowledgment from the second terminal device; and
generating the HARQ acknowledgment when the timer expires.

In an exemplary embodiment, the LBT delays may comprise delays occurring due to LBT operations and/or LBT failures.

In an exemplary embodiment, the first terminal device may be configured with multi-connection with the network device, and configuring a resource for the HARQ acknowledgment may comprise:
using an available resource on a connection different from the connection on which the transmission resources are received as the configured resource.

According to a second aspect of the present disclosure, a method for Side Link (SL) transmission on an Unlicensed band (SL-U), performed by a second terminal device is provided. The method includes: receiving an SL-U transmission from a first terminal device; generating a HARQ acknowledgement associated with the SL-U transmission; performing an LBT operation; if the LBT operation is successful but no Physical Sidelink Feedback Channel (PSFCH) resource is available within a given time period, finding an available SL resource; and transmitting the HARQ acknowledgement on the found available SL resource to the first terminal device

In an exemplary embodiment, finding an available SL resource may comprise:
finding available SL resources for a Physical Sidelink Shared Channel (PSSCH) or Physical Sidelink Common Control Channel (PSCCH) transmission towards the first terminal device within that time period; and
transmitting the HARQ acknowledgement on the found available SL resource may comprise:
transmitting the HARQ acknowledgement by multiplexing the HARQ acknowledgement in the PSSCH or PSCCH transmission towards the first terminal device.

In an exemplary embodiment, finding an available SL resources may comprise:
finding available SL resources on a connection different from the connection on which the SL-U transmission is received; and
transmitting the HARQ acknowledgement on the found available SL resource may comprise:
transmitting the HARQ acknowledgement on the available SL resources on the different connection.

According to a third aspect of the present disclosure, a method for Side Link (SL) transmission on an Unlicensed band (SL-U), performed by a network device provided. The method includes: configuring and transmitting transmission resources for SL-U transmission to a first terminal device to perform the SL-U transmission; configuring one or more resources for the HARQ acknowledgment associated with the SL-U transmission and transmitting the configured resource to the first terminal device; and receiving the HARQ acknowledgment from the first terminal device, wherein the configured resource is time compensated for Listen Before Talk (LBT) delays occurring during the SL-U transmission and/or during a transmission of the HARQ acknowledgement.

In an exemplary embodiment, transmitting the configured resource may be performed before transmitting the transmission resources; or upon transmitting the transmission resources; or after transmitting the transmission resources.

In an exemplary embodiment, transmitting the configured resource may comprise:
receiving a request from the first terminal device; and
allocating and transmitting one or more resources to the first terminal device.

In an exemplary embodiment, the request may be a Scheduling Request (SR) or a random access preamble for triggering a Random Access Channel (RACH) procedure.

In an exemplary embodiment, configuring one or more resources for the HARQ acknowledgment associated with the SL-U transmission and transmitting the configured resource to the first terminal device may comprise:
deciding one of a PUCCH resource or a Physical Uplink Shared Channel (PUSCH) resource to be configured; and
configuring the decided resource to the first terminal device.

In an exemplary embodiment, deciding one of a PUCCH resource or a PUSCH resource to be configured may comprise deciding one of a PUCCH resource or a PUSCH resource depending one of the following conditions:
deciding to configure a PUSCH resource if there is no free PUCCH resource;
deciding to configure a PUCCH resource if there is no free PUSCH resource;
deciding to configure a PUCCH resource if there are both a free PUCCH resource and a free PUSCH resource and a high transmission reliability for the HARQ acknowledgement is required; and
deciding to configure a PUSCH resource if there are both a free PUCCH resource and a free PUSCH resource and the HARQ acknowledgement doesn't require a high transmission reliability.

In an exemplary embodiment, the configured resource may be one or more or a combination of the following:
one or more PUCCH resources; and
one or more PUSCH resources.

In an exemplary embodiment, configuring one or more resources for the HARQ acknowledgment associated with the SL-U transmission and transmitting the configured resource to the first terminal device may comprise:
pre-configuring a set of resources to the first terminal device, and
transmitting the configured resource by indicating resources to the first terminal device by indices of resources in the set of resources.

In an exemplary embodiment, transmitting the configured resource to the first terminal device may comprise:
transmitting the configured resource using one of the following signaling:
   Radio Resource Control (RRC) signaling;
   Medium Access Control (MAC) Control Element (CE); and
L1 signaling.

In an exemplary embodiment, the LBT delays may comprise delays occurring due to LBT operations and/or LBT failures.

In an exemplary embodiment, the method may further include: waiting a configured time period before transmitting transmission resources for SL-U retransmission to the first terminal device if no HARQ acknowledgement for the SL-U transmission is received from the first terminal device at the configured resource.

According to a fourth aspect of the present disclosure, a terminal device is provided. The terminal device may include a transceiver, a processor and a memory. The memory may contain instructions executable by the processor whereby the terminal device is operative to perform the method according to the above first to second aspects.

According to a fifth aspect of the present disclosure, a computer readable storage medium is provided. The computer readable storage medium has computer program instructions stored thereon. The computer program instructions, when executed by a processor in a terminal device, cause the terminal device to perform the method according to the above first to second aspects.

According to a sixth aspect of the present disclosure, a network device is provided. The network device may include a transceiver, a processor and a memory. The memory may contain instructions executable by the processor whereby the network device is operative to perform the method according to the above third aspect.

According to a seventh aspect of the present disclosure, a computer readable storage medium is provided. The computer readable storage medium has computer program instructions stored thereon. The computer program instructions, when executed by a processor in a network device, cause the network device to perform the method according to the above third aspect.

According to an eighth aspect of the present disclosure, a communication system is provided. The communication system includes a host computer including: processing circuitry configured to provide user data; and a communication interface configured to forward the user data to a cellular network for transmission to a UE. The cellular network includes a network node, a transmission point, relay node, or a UE having a radio interface and processing circuitry. The network node's processing circuitry is configured to perform any of the methods according to the third aspect of the present disclosure.

In an exemplary embodiment, the communication system can further include the network node.

In an exemplary embodiment, the communication system can further include the UE. The UE is configured to communicate with the network node.

In an exemplary embodiment, the processing circuitry of the host computer can be configured to execute a host application, thereby providing the user data. The UE can include processing circuitry configured to execute a client application associated with the host application.

According to a ninth aspect of the present disclosure, a method is provided. The method is implemented in a communication system including a host computer, a network node and a UE. The method includes: at the host computer, providing user data; and at the host computer, initiating a transmission carrying the user data to the UE via a cellular network including the network node. The network node can perform any of the methods according to the third aspect of the present disclosure.

In an exemplary embodiment, the method further can include: at the network node, transmitting the user data.

In an exemplary embodiment, the user data can be provided at the host computer by executing a host application. The method can further include: at the UE, executing a client application associated with the host application.

According to a tenth aspect of the present disclosure, a communication system is provided. The communication system includes a host computer including: processing circuitry configured to provide user data; and a communication interface configured to forward user data to a cellular network for transmission to a UE. The UE includes a radio interface and processing circuitry. The UE's processing circuitry is configured to perform any of the methods according to the first to second aspects of the present disclosure.

In an exemplary embodiment, the communication system can further include the UE.

In an exemplary embodiment, the cellular network can further include a network node configured to communicate with the UE.

In an exemplary embodiment, the processing circuitry of the host computer can be configured to execute a host application, thereby providing the user data. The UE's processing circuitry can be configured to execute a client application associated with the host application.

According to an eleventh aspect of the present disclosure, a method is provided. The method is implemented in a communication system including a host computer, a network node and a UE. The method includes: at the host computer, providing user data; and at the host computer, initiating a transmission carrying the user data to the UE via a cellular network including the network node. The UE can perform any of the methods according to the first to second aspects of the present disclosure.

In an exemplary embodiment, the method can further include: at the UE, receiving the user data from the network node.

According to a twelfth aspect of the present disclosure, a communication system is provided. The communication system includes a host computer including: a communication interface configured to receive user data originating from a transmission from a UE to a network node. The UE includes a radio interface and processing circuitry. The UE's processing circuitry is configured to: perform any of the methods according to the first to second aspects of the present disclosure.

In an exemplary embodiment, the communication system can further include the UE.

In an exemplary embodiment, the communication system can further include the network node. The network node can include a radio interface configured to communicate with the UE and a communication interface configured to forward to the host computer the user data carried by a transmission from the UE to the network node.

In an exemplary embodiment, the processing circuitry of the host computer can be configured to execute a host application. The UE's processing circuitry can be configured to execute a client application associated with the host application, thereby providing the user data.

In an exemplary embodiment, the processing circuitry of the host computer can be configured to execute a host application, thereby providing request data. The UE's processing circuitry can be configured to execute a client application associated with the host application, thereby providing the user data in response to the request data.

According to a thirteenth aspect of the present disclosure, a method is provided. The method is implemented in a communication system including a host computer, a network node and a UE. The method includes: at the host computer, receiving user data transmitted to the network node from the UE. The UE can perform any of the methods according to the first to second aspects of the present disclosure.

In an exemplary embodiment, the method can further include: at the UE, providing the user data to the network node.

In an exemplary embodiment, the method can further include: at the UE, executing a client application, thereby providing the user data to be transmitted; and at the host computer, executing a host application associated with the client application.

In an exemplary embodiment, the method can further include: at the UE, executing a client application; and at the UE, receiving input data to the client application, the input data being provided at the host computer by executing a host application associated with the client application. The user data to be transmitted is provided by the client application in response to the input data.

According to a fourteenth aspect of the present disclosure, a communication system is provided. The communication system includes a host computer including a communication interface configured to receive user data originating from a transmission from a UE to a network node. The network node includes a radio interface and processing circuitry. The network node's processing circuitry is configured to perform any of the methods according to the second aspect of the present disclosure.

In an exemplary embodiment, the communication system can further include the network node.

In an exemplary embodiment, the communication system can further include the UE. The UE can be configured to communicate with the network node.

In an exemplary embodiment, the processing circuitry of the host computer can be configured to execute a host application; the UE can be configured to execute a client application associated with the host application, thereby providing the user data to be received by the host computer.

According to a fifteenth aspect of the present disclosure, a method is provided. The method is implemented in a communication system including a host computer, a network node and a UE. The method includes: at the host computer, receiving, from the network node, user data originating from a transmission which the network node has received from the UE. The network node can perform any of the methods according to the third aspect of the present disclosure.

In an exemplary embodiment, the method can further include: at the network node, receiving the user data from the UE.

In an exemplary embodiment, the method can further include: at the network node, initiating a transmission of the received user data to the host computer.

With the technical solutions according to the exemplary embodiments of the present disclosure as described above, the terminal devices can timely provide a HARQ acknowledgement associated with the SL-U transmission to the network devices. The negative impact on Quality of Service (QOS) performance of services due to LBT delays is thus minimized.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates an example of Channel Occupancy Time (COT) sharing;

FIG. 2 illustrates an example of a User Equipment (UE) initiated COT;

FIG. 3 illustrates an example of the Frame Based Equipment (FBE) based channel occupancy operation;

FIG. 4 schematically illustrates a diagram of a wireless communication system where the present application may be implemented;

FIG. 5 schematically shows a method for SL transmission on an Unlicensed band (SL-U) performed by a first terminal device according to an exemplary embodiment of the present disclosure according to an exemplary embodiment of the present disclosure;

FIG. 6 illustrates an example in which the present disclosure may be implemented.

FIG. 7 schematically shows a method for SL transmission on an Unlicensed band (SL-U) performed by a second terminal device according to an exemplary embodiment of the present disclosure;

FIG. 8 schematically shows a method for SL transmission on an Unlicensed band (SL-U) performed by a network device according to an exemplary embodiment of the present disclosure;

FIG. 9 schematically shows a structural block diagram of a terminal device according to an exemplary embodiment of the present disclosure;

FIG. 10 schematically shows a structural block diagram of a terminal device according to another exemplary embodiment of the present disclosure;

FIG. 11 schematically shows a structural block diagram of a network device according to an exemplary embodiment of the present disclosure;

FIG. 12 schematically shows a structural block diagram of a network device according to another exemplary embodiment of the present disclosure;

FIG. 13 schematically illustrates a schematic diagram of an exemplary network architecture illustrating a communication system connected via an intermediate network to a host computer according to the principles in the present disclosure;

FIG. 14 schematically illustrates a generalized block diagram of a host computer communicating via a network node with a UE over an at least partially wireless connection according to some embodiments of the present disclosure;

FIG. 15 schematically illustrates a flowchart illustrating exemplary methods implemented in a communication system including a host computer, a network node and a UE for executing a client application at a UE according to some embodiments of the present disclosure;

FIG. 16 schematically illustrates a flowchart illustrating exemplary methods implemented in a communication system including a host computer, a network node and a UE for receiving user data at a UE according to some embodiments of the present disclosure;

FIG. 17 schematically illustrates a flowchart illustrating exemplary methods implemented in a communication system including a host computer, a network node and a UE for receiving user data from the UE at a host computer according to some embodiments of the present disclosure; and

FIG. 18 schematically illustrates a flowchart illustrating exemplary methods implemented in a communication system including a host computer, a network node and a UE for receiving user data at a host computer according to some embodiments of the present disclosure.

### DETAILED DESCRIPTION

Hereinafter, the principle and spirit of the present disclosure will be described with reference to illustrative embodiments. Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Additional information may also be found in references as follows:
1) 3GPP TS 37.213 V16.6.0, “Physical layer procedures for shared spectrum channel access (Release 16)” (2021 June), and
2) 3GPP TR 38.889 v16.0.0, “Study on NR-based access to unlicensed spectrum (Release 16)” (2018 December)

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

As used herein, the non-limiting term “wireless communication network” refers to a network following any suitable communication standards, such as NR, Long Term Evolution (LTE), LTE-Advanced (LTE-A), Wideband Code Division Multiple Access (WCDMA), High-Speed Packet Access (HSPA), and so on. Furthermore, the communications between a terminal device and a network device in the wireless communication network may be performed according to any suitable generation communication protocols, including, but not limited to, Global System for Mobile Communications (GSM), Universal Mobile Telecommunications System (UMTS), LTE, and/or other suitable 1G (the first generation), 2G (the second generation), 2.5G, 2.75G, 3G (the third generation), 4G (the fourth generation), 4.5G, 5G (the fifth generation) communication protocols, wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards, and/or any other protocols either currently known or to be developed in the future.

The non-limiting term “network node” or “network device” refers to a device in a wireless communication network via which a terminal device accesses the network and receives services therefrom. The network node or network device refers to any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. More generally, however, the network device may represent any suitable device (or group of devices) capable, configured, arranged, and/or operable to enable and/or provide a terminal device access to the wireless communication network or to provide some service to a terminal device that has accessed the wireless communication network.

The non-limiting term “terminal device” refers to any end device that can access a wireless communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, portable computers, desktop computers, image capture terminal devices such as digital cameras, gaming terminal devices, music storage and playback appliances, a mobile phone, a cellular phone, a smart phone, voice over IP (VoIP) phones, wireless local loop phones, tablets, personal digital assistants (PDAs), wearable terminal devices, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3rd Generation Partnership Project (3GPP), such as 3GPP's GSM, UMTS, LTE, and/or 5G standards. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be configured to transmit information to a network on a predetermined schedule, when triggered by an internal or external event, or in response to requests from the wireless communication network. Instead, a UE may represent a device that is intended for sale to, or operation by, a human user but that may not initially be associated with a specific human user.

The terminal device may support device-to-device (D2D) communication, for example by implementing a 3GPP standard for sidelink communication, and may in this case be referred to as a D2D communication device.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the present disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a UE or a network node may be distributed over a plurality of UEs and/or network nodes. In other words, it is contemplated that the functions of the network node and UE described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

The embodiments of the present disclosure can be applied to e.g., NR Radio Access Technology (RAT), LTE RAT and any other RAT enabling direct communication between two (or more) nearby devices.

As previously described, the link or radio link over which signals are transmitted between at least two UEs for D2D operations is called herein as a sidelink. The signals transmitted between the UEs for D2D operation can be referred to herein as SL signals. The term SL may also interchangeably be called as D2D link, vehicle to everything (V2X) link, ProSe link, peer-to-peer link, PC5 link etc. The SL signals may also interchangeably be called as V2X signals, D2D signals, ProSe signals, PC5 signals, peer-to-peer signals etc.

The embodiments are described in the context of NR, i.e., two or more SL UEs are deployed in a same or different NR cell. However, the same principle may be applied to LTE or any other technology that enables the direct connection of two (or more) nearby devices. The embodiments are also applicable to relay scenarios including UE to network relay or UE to UE relay where the remote UE and the relay UE may be based on LTE sidelink or NR sidelink, the Uu connection between the relay UE and the base station may be LTE Uu or NR Uu.

In order to tackle an ever increasing data demand, NR is supported on both a licensed and unlicensed spectrum. NR supported on an unlicensed spectrum is referred to as NR-U. Herein, a licensed spectrum (or licensed band) can be defined as a set of (e.g. radio) frequencies that is licensed to one or more predefined users. The one or more predefined users have the exclusive right to transmit on one or more frequencies from such a licensed spectrum. In exchange, the one or more predefined users can be assured that nothing will interfere with their transmission. On the other hand, an unlicensed spectrum (or unlicensed band) can be defined as a set of (e.g. radio) frequencies that is not licensed to any predefined users. One or more users can transmit on one or more frequencies from such an unlicensed spectrum without acquiring permission to do so.

Compared to long term evolution (LTE) licensed assisted access (LAA), NR-U supports dual connectivity (DC) and standalone scenarios, where the medium access control (MAC) procedures including random access channel (RACH) and scheduling procedure on an unlicensed spectrum are subject to Listen Before Talk (LBT) failures, while there is no such restriction in LTE LAA, since there is licensed spectrum in LAA scenario so the RACH and scheduling related signaling can be transmitted on the licensed spectrum instead of the unlicensed spectrum.

For discovery reference signal (DRS) transmission such as primary synchronization signal (PSS)/secondary synchronization signal (SSS), physical broadcast channel (PBCH), channel state information reference signal (CSI-RS), control channel transmission such as physical uplink control channel (PUCCH)/physical downlink control channel (PDCCH), physical data channel such as physical uplink shared channel (PUSCH)/physical downlink shared channel (PDSCH), and uplink sounding reference signal such as sounding reference signal (SRS) transmission, channel sensing is to be applied to determine the channel availability before the physical signal is transmitted using the channel.

The radio resource management (RRM) procedures in NR-U is generally rather similar as in LAA, since NR-U is aiming to reuse LAA/enhanced LAA (eLAA)/further enhanced LAA (feLAA) technologies as much as possible to handle the coexistence between NR-U and other legacy radio access technologies (RATs). RRM measurements and report comprise special configuration procedure with respect to the channel sensing and channel availability.

Hence, channel access/selection for LAA is one important aspect for co-existence with other RATs such as Wi-Fi. For instance, LAA has aimed to use carriers that are congested with Wi-Fi.

In licensed spectrum, user equipment (UE) measures Reference Signal Received Power (RSRP), and Reference Signal Received Quality (RSRQ) of a downlink radio channel (e.g. synchronization signal block (SSB), CSI-RS), and provides the measurement reports to its serving evolved NodeB (eNB)/next generation NB (gNB). However, they do not reflect the interference strength on the carrier. Another metric Received Signal Strength Indicator (RSSI) can serve for such purpose. At the eNB/gNB side, it is possible to derive RSSI based on the received RSRP and RSRQ reports. However, this requires that they must be available. Due to the LBT failure, some reports in terms of RSRP or RSRQ may be blocked (i.e. either due to the reference signal transmission (DRS) being blocked in the downlink or the measurement report being blocked in the uplink). Hence, the measurements in terms of RSSI are very useful. The RSSI measurements together with time information concerning when and how long (e.g. the amount of) time that UEs have made the measurements can assist the gNB/eNB to detect the hidden node. Additionally, the gNB/eNB can measure the load situation of the carrier which is useful for the network to prioritize some channels for load balance and channel access failure avoidance purposes.

LTE LAA has been defined to support measurements of averaged RSSI and channel occupancy for measurement reports. The channel occupancy is defined as the percentage of time that the RSSI is measured above a configured threshold. For this purpose, an RSSI measurement timing configuration (RMTC) includes a measurement duration (e.g. 1-5 ms) and a period between measurements (e.g. {40, 80, 160, 320, 640} ms).

In the art, the LBT protocol is understood to be a mechanism that allows Wi-Fi and LTE systems to share the unlicensed spectrum. Access to a channel in the unlicensed spectrum, especially in the 5 GHz and 6 GHz band, is guaranteed by LBT requirements defined by regulations, unlike the licensed spectrum which is assigned to a specific operator.

The LBT mechanism mandates a device to sense for the presence of other users' transmissions in the channel before attempting to transmit. The device performs clear channel assessment (CCA) checks on the channel using energy detection (ED) before transmitting. If the channel is found to be idle, i.e. energy detected is below a certain threshold, the device is allowed to transmit. Otherwise, if the channel is found to be occupied, the device must defer from transmitting. This mechanism reduces interferences and collisions to other systems and increases probabilities of successful transmissions when the energy in a CCA slot is sensed to be below the ED threshold. Regulatory requirements in some regions specify the maximum allowed ED threshold, thus setting a limit on the most aggressive behavior that transmitters may have.

As described in the 3GPP technical report (TR) 38.889 v16.0.0, the channel access schemes for NR-based access for unlicensed spectrum can be classified into the following categories:

### Category 1: Immediate Transmission After a Short Switching Gap, I.e., Also Referred to as No LBT Operation

This is used for a transmitter to immediately transmit after a UL/DL switching gap inside a COT.
The switching gap from reception to transmission is to accommodate the transceiver turnaround time and is no longer than 16 μs.
Category 2: LBT without random back-off (also referred to as one shot LBT)
The duration of time that the channel is sensed to be idle before the transmitting entity transmits is deterministic.

### Category 3: LBT With Random Back-Off With a Contention Window of Fixed Size

The LBT procedure has the following procedure as one of its components. The transmitting entity draws a random number N within a contention window. The size of the contention window is specified by the minimum and maximum value of N. The size of the contention window is fixed. The random number N is used in the LBT procedure to determine the duration of time that the channel is sensed to be idle before the transmitting entity transmits on the channel.

### Category 4: LBT With Random Back-Off With a Contention Window of Variable Size

The LBT procedure has the following as one of its components. The transmitting entity draws a random number N within a contention window. The size of contention window is specified by the minimum and maximum value of N. The transmitting entity can vary the size of the contention window when drawing the random number N. The random number N is used in the LBT procedure to determine the duration of time that the channel is sensed to be idle before the transmitting entity transmits on the channel.

For different transmissions in a COT and different channels/signals to be transmitted, different categories of channel access schemes can be used.

NR-U supports two different LBT modes, dynamic and semi-static channel occupancy for two types of equipment; Load based Equipment (LBE) and Frame based equipment (FBE), respectively.

For a node (e.g., NR-U gNB/UE, LTE-LAA eNB/UE, or Wi-Fi access point (AP)/station (STA)) to be allowed to transmit in the unlicensed spectrum (e.g., 5 GHz band), it typically needs to perform a clear channel assessment (CCA). This procedure typically includes sensing the medium to be idle for a number of time intervals. Sensing the medium to be idle can be performed in different ways, e.g. using energy detection, preamble detection or using virtual carrier sensing. Where the latter implies that the node reads control information from other transmitting nodes informing when a transmission ends. After sensing the medium to be idle, the node is typically allowed to transmit for a certain amount of time, sometimes referred to as transmission opportunity (TXOP). The length of the TXOP depends on regulation and type of CCA that has been performed, but typically ranges from 1 ms to 10 ms. This duration is often referred to as a COT (Channel Occupancy Time).

In Wi-Fi, feedback of data reception acknowledgements (ACKs) is transmitted without performing clear channel assessment. Preceding feedback transmission, a small time duration (called SIFS) is introduced between the data transmission and the corresponding feedback which does not include actual sensing of the channel. In Institute of Electrical and Electronics Engineers (IEEE) 802.11, the SIFS period (16 μs for 5 GHz orthogonal frequency-division multiplexing (OFDM) physical layers (PHYs)) is defined as:

aSIFSTime=aRxPHYDelay+aMACProcessingDelay+aRxTxTurnaroundTime.
aRxPHYDelay defines the duration needed by the PHY layer to deliver a packet to the MAC layer.
aMACProcessingDelay defines the duration that the MAC layer needs to trigger the PHY layer transmitting a response.
aRxTxTurnaroundTime defines the duration needed to turn the radio from reception into transmit mode.

Therefore, the SIFS duration is used to accommodate for the hardware delay to switch the direction from reception to transmission.

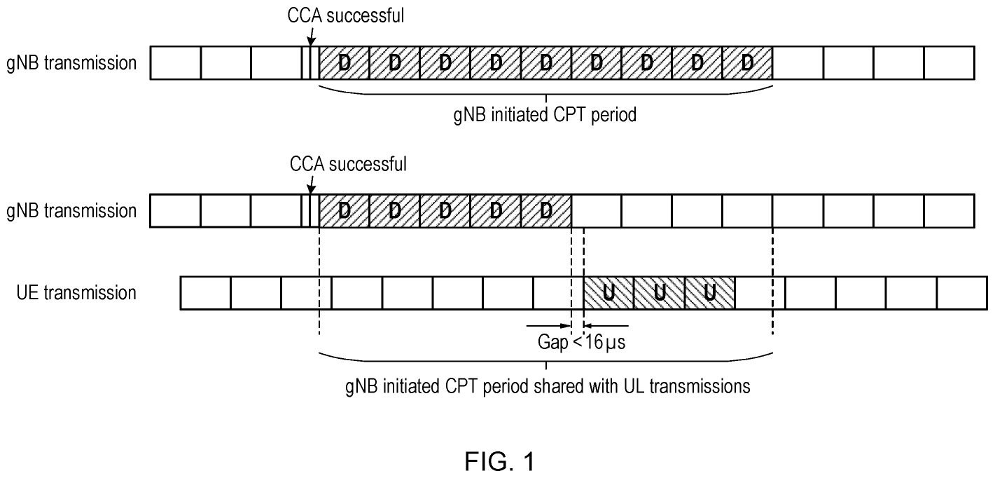

It is anticipated that for NR in the unlicensed bands (NR-U), a similar gap to accommodate for the radio turnaround time will be allowed. For example, this will enable the transmission of PUCCH carrying uplink control information (UCI) feedback as well as PUSCH carrying data and possible UCI within the same transmit opportunity (TXOP) acquired by the initiating gNB without the UE performing clear channel assessment before PUSCH/PUCCH transmission as long as the gap between downlink (DL) and uplink (UL) transmission is less than or equal to 16 μs. Operation in this manner is typically called “COT sharing”. An example of COT sharing is illustrated in FIG. 1. FIG. 1 illustrates transmission opportunities (TXOP) both with and without COT sharing where CCA is performed by the initiating node (gNB). For the case of COT sharing, the gap between DL and UL transmissions is less than 16 μs.

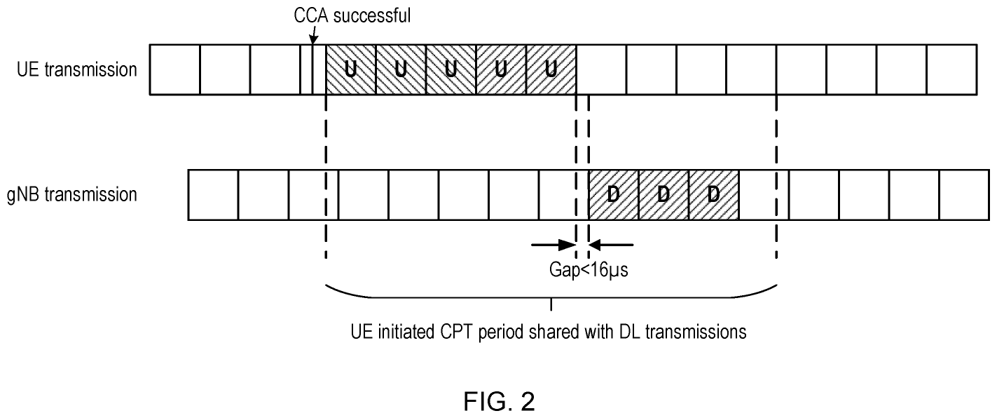

When UE accesses medium via category 4 (Cat-4) LBT with a configured grant outside of a gNB COT, it is also possible for UE and gNB to share the UE acquired COT to schedule DL data to the same UE. UE COT information can be indicated in UCI such as configured grant (CG)-UCI for configured grant PUSCH resources. An example of a UE initiated COT is illustrated in FIG. 2. FIG. 2 illustrates an example of a UE COT sharing with the DL transmission. For the case of COT sharing, the gap between UL and DL transmission is less than 16us.

Release 16 (Rel-16) Work Item (WI) NR-U specifies a dynamic channel access mechanism for an LBE type device.

This procedure randomizes the start of transmissions from different nodes that want to access the channel at the same time.

This procedure is commonly known as category 4 (CAT4) LBT, the detailed procedure for category 4 LBT (also named as Type 1 channel access in 3GPP technical standard (TS) 37.213 V16.6.0) is described as below.

A UE may transmit the transmission using Type 1 channel access procedure after first sensing the channel to be idle during the slot durations of a defer duration T_{d}, and after the counter N is zero in step 4. The counter N is adjusted by sensing the channel for additional slot duration(s) according to the steps described below.
1) set N=Nᵢₙᵢₜ, where Nᵢₙᵢₜ is a random number uniformly distributed between 0 and CWₚ, and go to step 4;
2) if N>0 and the UE chooses to decrement the counter, set N=N−1;
3) sense the channel for an additional slot duration, and if the additional slot duration is idle, go to step 4; else, go to step 5;
4) if N=0, stop; else, go to step 2;
5) sense the channel until either a busy slot is detected within an additional defer duration T_{d}, or all the slots of the additional defer duration T_{d} are detected to be idle; and
6) if the channel is sensed to be idle during all the slot durations of the additional defer duration T_{d}, go to step 4; else, go to step 5.

If a UE has not transmitted a UL transmission on a channel on which UL transmission(s) are performed after step 4 in the procedure above, the UE may transmit a transmission on the channel, if the channel is sensed to be idle at least in a sensing slot duration Tₛₗ when the UE is ready to transmit the transmission and if the channel has been sensed to be idle during all the slot durations of a defer duration T_{d} immediately before the transmission. If the channel has not been sensed to be idle in a sensing slot duration Tₛₗ when the UE first senses the channel after it is ready to transmit, or if the channel has not been sensed to be idle during any of the sensing slot durations of a defer duration T_{d} immediately before the intended transmission, the UE proceeds to step 1 after sensing the channel to be idle during the slot durations of a defer duration T_{d}.

The defer duration T_{d} consists of duration T_{ƒ}=16 us immediately followed by mp consecutive slot durations where each slot duration is Tₛₗ=9 us, and T_{ƒ} includes an idle slot duration Tₛₗ at start of T_{ƒ}. CW_{min,p}≤CWₚ≤CW_{max,p} is the contention window. CWₚ adjustment is described in clause 4.2.2 of TS 37.213 v16.6.0. CW_{min,p} and CW_{max,p} are chosen before step 1 of the procedure above. mₚ, CW_{min,p}, and CW_{max,p} are based on a channel access priority class p as shown in Table 4.2.1-1 of TS 37.213 v16.6.0.

| Channel | | | | | |
|---|---|---|---|---|---|
| Access | | | | | allowed |
| Priority | | | | | CWₚ |
| Class (p) | mₚ | CWₘ | CW_{max, p} | T_{ulmcot, p} | sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 ms | {15, 31, 63, 127, |
| | | | | | 255, 511, 1023} |
| 4 | 7 | 15 | 1023 | 6 ms or 10 ms | {15, 31, 63, 127, |
| | | | | | 255, 511, 1023} |

NOTE1:
For p = 3, 4, T_{ulmcot, p} = 10 ms if the higher layer parameter absenceOfAnyOtherTechnology-r14 or absenceOfAnyOtherTechnology-r16 is provided, otherwise, T_{ulmcot, p} = 6 ms.
NOTE 2:
When T_{ulmcot, p} = 6 ms it may be increased to 8 ms by inserting one or more gaps. The minimum duration of a gap shall be 100 μs. The maximum duration before including any such gap shall be 6 ms.

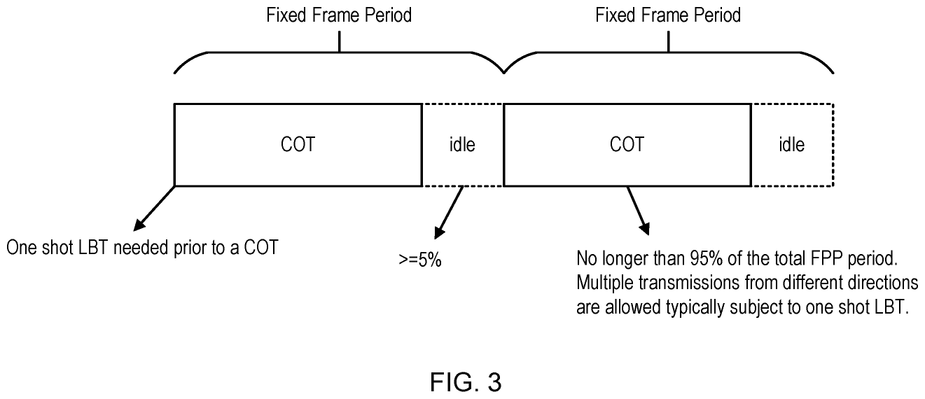

The semi-static channel occupancy allows a frame based equipment (FBE) to perform a clear channel assessment per fixed frame period for a duration of a single 9 μs observation slot. If the channel is found to be busy after CCA operation, the equipment is to not transmit during this fixed frame period. The fixed frame period can be set to a value between 1 and 10 ms and can be adjusted once every 200 ms. If the channel is found to be idle, the equipment can transmit immediately up to a duration referred to as channel occupancy time, after which the equipment is to remain silent for at least 5% of said channel occupancy time. At the end of the required idle period, the equipment can resume CCA for channel access. An example of the FBE based channel occupancy operation is shown in FIG. 3.

The semi-static channel occupancy generally has difficulty competing with devices that use dynamic channel occupancy (such as LAA or NR-U) for channel access. A dynamic channel occupancy device has the flexibility to access the channel at any time after a successful LBT procedure, while the semi-static channel occupancy devices has one chance for grabbing the channel every fixed frame period. The problems become more exacerbated with longer fixed frame period and higher traffic load. Secondly, the frame based LBT can be rather inflexible for coordinating channel access between networks. If all the nodes are synchronized, then all nodes will find the channel available and transmit simultaneously and cause interference. If the nodes are not synchronized, then some nodes may have definitive advantages in getting access to the channel over some other nodes. Nonetheless, semi-static channel occupancy can be a good choice for controlled environments, where a network owner can guarantee absence of dynamic channel occupancy devices and is in control of the behavior of all devices competing to access the channel. In fact, in such deployment, semi-static channel occupancy is an attractive solution because access latencies can be reduced to the minimum and lower complexity is required for channel access due to lack of necessity to perform random backoff.

It has been identified that FBE operation for the scenario where it is guaranteed that LBE nodes are absent on a long-term basis (e.g., by level of regulation) and FBE gNBs are synchronized can achieve the following:
Ability to use frequency reuse factor 1;
Lower complexity for channel access due to lack of necessity to perform random backoff.

In order to deploy a single operator FBE system, the gNBs need to be time aligned. All gNBs will perform the one-shot 9 us LBT at the same time. If the gNB indicates FBE operation, for an indication of LBT type of Cat2 25 μs or Cat4 the UE follows the mechanism whereby one 9 microsecond slot is measured within a 25-microsecond interval.

The fixed frame period (FFP) is restricted to values of {1 ms, 2 ms, 2.5 ms, 4 ms, 5 ms, 10 ms} (this is included in the idle period). The starting positions of the FFPs within every two radio frames starts from an even radio frame and are given by i*P where i={0, 1, . . . , 20/P−1} where P is the fixed frame period in ms.

The idle period for a given SCS=ceil (Minimum idle period allowed by regulations/Ts) where minimum idle period allowed=max(5% of FFP, 100 us), and Ts is the symbol duration for the given SCS.

For FBE, channel sensing is performed at fixed time instants. If the channel is determined busy, the base station adopts a fixed back-off and performs LBT again after the fixed backoff. For LBE, channel sensing can be performed at any time instance, and random back-off is adopted when the channel is determined to be busy.

As described in 3GPP TR 38.889 v16.6.0, it has been identified that FBE operation for the scenario where it is guaranteed that LBE nodes are absent on a long term basis (e.g., by level of regulation) and FBE gNBs are synchronized can achieve the following: Ability to use frequency reuse factor 1; Lower complexity for channel access due to lack of necessity to perform random backoff. It is noted that this does not imply that LBE does not have benefits in similar scenarios although there are differences between the two modes of operation. It is also noted that FBE may also have some disadvantages compared to other modes of operation such as LBE, e.g., a fixed overhead for idle time during a frame.

In NR Release (Rel-16), it is only gNB COT sharing is supported in case of semi-static channel access by FBE. A UE may transmit UL transmission burst(s) after DL transmission within a gNB initiated COT. UE transmissions within a fixed frame period can occur if DL transmissions for the serving gNB within the fixed frame period are detected. The detection of any DL transmission confirms that the gNB has initiated the COT. For this to work, the UE is to be aware of the start and end of every FFP cycle. Such UE behaviors are not optimum for ultra reliable low latency communication (URLLC) like services which require critical latency requirements. UE initiated COT by FBE can be a complementary solution for URLLC.

Sidelink transmissions over NR are specified for Rel-16. These are enhancements of the ProSe (PROximity-based SErvices) specified for LTE. Four new enhancements are particularly introduced to NR sidelink transmissions as follows:
Support for unicast and groupcast transmissions are added in NR sidelink. For unicast and groupcast, the physical sidelink feedback channel (PSFCH) is introduced for a receiver UE to reply the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a new version of PSCCH.
To achieve a high connection density, congestion control and thus the quality of service (QOS) management is supported in NR sidelink transmissions.

To enable the above enhancements, new physical channels and reference signals are introduced in NR (available in LTE before):
PSSCH (Physical Sidelink Shared Channel, SL version of PDSCH): The PSSCH is transmitted by a sidelink transmitter UE, which conveys sidelink transmission data, system information blocks (SIBs) for radio resource control (RRC) configuration, and a part of the sidelink control information (SCI).
PSFCH (Physical Sidelink feedback channel): The PSFCH is transmitted by a sidelink receiver UE for unicast and groupcast, which conveys 1 bit information over 1 resource block (RB) for the Hybrid Automatic Repeat Request (HARQ) acknowledgement (ACK) and the negative ACK (NACK). In addition, channel state information (CSI) is carried in the medium access control (MAC) control element (CE) over the PSSCH instead of the PSFCH.
PSCCH (Physical Sidelink Common Control Channel, SL version of PDCCH): When the traffic to be sent to a receiver UE arrives at a transmitter UE, a transmitter UE is to first send the PSCCH, which conveys a part of SCI (Sidelink Control information, SL version of downlink control information (DCI)) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitter the S-PSS/S-SSS. A series of processes of acquiring timing and frequency synchronization together with SSIDs of UEs is called initial cell search. Note that the UE sending the S-PSS/S-SSS may not be necessarily involved in sidelink transmissions, and a node (UE/eNB/gNB) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB is to be transmitted within the bandwidth of the configured bandwidth part (BWP). The PSBCH conveys information related to synchronization, such as the direct frame number (DFN), indication of the slot and symbol level time resources for sidelink transmissions, in-coverage indicator, etc. The SSB is transmitted periodically at every 160 ms.
DMRS, phase tracking reference signal (PT-RS), channel state information reference signal (CSIRS): These physical reference signals supported by NR downlink/uplink transmissions are also adopted by sidelink transmissions. Similarly, the PT-RS is only applicable for frequency range 2 (FR2) transmission.

Another new feature is the two-stage sidelink control information (SCI). This is a version of the DCI for SL. Unlike the DCI, only part (first stage) of the SCI is sent on the PSCCH. This part is used for channel sensing purposes (including the reserved time-frequency resources for transmissions, demodulation reference signal (DMRS) pattern and antenna port, etc.) and can be read by all UEs while the remaining (second stage) scheduling and control information such as an 8-bits source identity (ID) and a 16-bits destination ID, NDI, RV and HARQ process ID is sent on the PSSCH to be decoded by the receiver UE.

Similar as for ProSE in LTE, NR sidelink transmissions have the following two modes of resource allocations:
Mode 1: Sidelink resources are scheduled by a gNB.
Mode 2: The UE autonomously selects sidelink resources from a (pre-)configured sidelink resource pool(s) based on the channel sensing mechanism.

For the in-coverage UE, a gNB can be configured to adopt Mode 1 or Mode 2. For the out-of-coverage UE, only Mode 2 can be adopted.

As in LTE, scheduling over the sidelink in NR is performed in different ways for Mode 1 and Mode 2.

### Mode 1 Supports the Following Two Kinds Of Grants

Dynamic grant: When the traffic to be sent over sidelink arrives at a transmitter UE, this UE is to launch the four-message exchange procedure to request sidelink resources from a gNB (SR on UL, grant, BSR on UL, grant for data on SL sent to UE). During the resource request procedure, a gNB may allocate a sidelink radio network temporary identifier (SL-RNTI) to the transmitter UE. If this sidelink resource request is granted by a gNB, then a gNB indicates the resource allocation for the PSCCH and the PSSCH in the downlink control information (DCI) conveyed by PDCCH with cyclic redundancy check (CRC) scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single transport block (TB). As a result, this kind of grant is suitable for traffic with a loose latency requirement.
Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE cannot receive the DCI (since it is addressed to the transmitter UE), and therefore a receiver UE is to perform blind decoding to identify the presence of PSCCH and find the resources for the PSSCH through the SCI.

When a transmitter UE launches the PSCCH, CRC is also inserted in the SCI without any scrambling.

In the Mode 2 resource allocation, when traffic arrives at a transmitter UE, this transmitter UE is to autonomously select resources for the PSCCH and the PSSCH. To further minimize the latency of the feedback HARQ ACK/NACK transmissions and subsequently retransmissions, a transmitter UE may also reserve resources for PSCCH/PSSCH for retransmissions. To further enhance the probability of successful TB decoding at one shot and thus suppress the probability to perform retransmissions, a transmitter UE may repeat the TB transmission along with the initial TB transmission. This mechanism is also known as blind retransmission. As a result, when traffic arrives at a transmitter UE, then this transmitter UE is to select resources for the following transmissions:
1) The PSSCH associated with the PSCCH for initial transmission and blind retransmissions.
2) The PSSCH associated with the PSCCH for retransmissions.

Since each transmitter UE in sidelink transmissions is to autonomously select resources for above transmissions, how to prevent different transmitter UEs from selecting the same resources turns out to be a critical issue in Mode 2. A particular resource selection procedure is therefore imposed to Mode 2 based on channel sensing. The channel sensing algorithm involves measuring RSRP on different subchannels and requires knowledge of the different UEs power levels of DMRS on the PSSCH or the DMRS on the PSCCH depending on the configuration. This information is known only after receiver SCI launched by (all) other UEs. The sensing and selection algorithm is rather complex.

The proposed mechanism is applicable to SL unlicensed operations (i.e., SL transmission on an unlicensed band). The term LBT may also interchangeably be called clear channel assessment (CCA), shared spectrum access procedure etc. The carrier on which the LBT is applied may belong to a shared spectrum or an unlicensed band or band with contention based access etc.

The configurable LBT schemes can comprise at least one of the below LBT categories/types, but are not limited to the below examples:

### Category 1: Immediate Transmission After a Short Switching Gap, I.e., Also Referred to as No LBT Operation

This is used for a transmitter to immediately transmit after an uplink (UL)/downlink (DL) switching gap inside a channel occupancy time (COT).
The switching gap from reception to transmission is to accommodate the transceiver turnaround time and is no longer than 16 μs.

### Category 2: LBT Without Random Back-Off (Also Referred to as One Shot LBT)

The duration of time that the channel is sensed to be idle before the transmitting entity transmits is deterministic.

### Category 3: LBT With Random Back-Off With a Contention Window of Fixed Size

The LBT procedure has the following procedure as one of its components. The transmitting entity draws a random number N within a contention window. The size of the contention window is specified by the minimum and maximum value of N. The size of the contention window is fixed. The random number N is used in the LBT procedure to determine the duration of time that the channel is sensed to be idle before the transmitting entity transmits on the channel.

### Category 4: LBT With Random Back-Off With a Contention Window of Variable Size

The LBT procedure has the following as one of its components. The transmitting entity draws a random number N within a contention window. The size of contention window is specified by the minimum and maximum value of N. The transmitting entity can vary the size of the contention window when drawing the random number N. The random number N is used in the LBT procedure to determine the duration of time that the channel is sensed to be idle before the transmitting entity transmits on the channel.

The other LBT schemes such as directional LBT, omni directional LBT, or receiver assisted LBT are also applicable. In addition, both LBE based channel access schemes and FBE based channel access schemes are covered in the following embodiments.

The LBT schemes may be also referred to as other terms e.g., Type 1 or Type 2 channel access procedures as specified in the 3GPP TS 37.213 v 16.6.0.

In the existing unlicensed operation technologies (e.g., an LTE unlicensed operation or NR unlicensed operation), the gap from the end of a first transmission in one direction (e.g., from UE1 to UE2) to the beginning of a second transmission in the other direction (e.g., from UE2 to UE1) may not be more than a fixed period (e.g., 16 μs or 25 μs). Either Category 1 or Category 2 LBT can be chosen prior to the second transmission, such as to avoid latency incurred by usage of Category 4 LBT operations. For SL transmissions, similar gap periods may also be introduced. However, the value of the gap period may be different from the ones used in the existing unlicensed operation technologies.

The following embodiments are applicable to SL transmissions on an unlicensed band with any cast type including unicast, groupcast and broadcast.

In the following embodiments, it is assumed that SL transmissions are on an unlicensed band, while Uu transmissions may be on a licensed or unlicensed band.

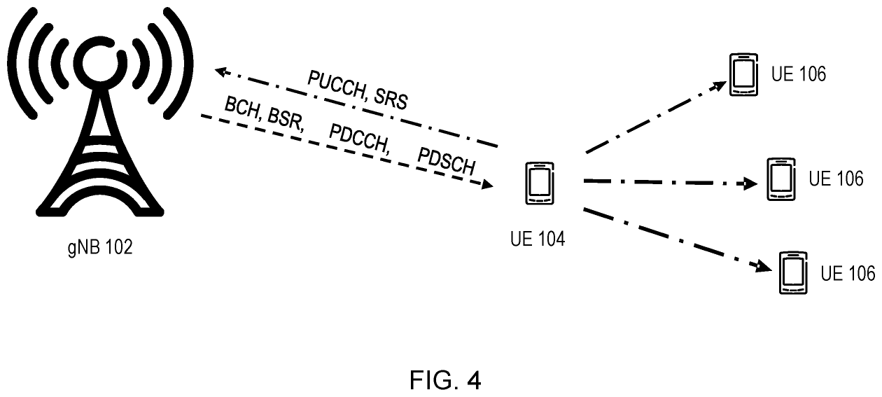

The embodiments of the present disclosure are in general applicable to scenarios where a terminal device is served by a network device, and also has SL connection(s) with another terminal device. FIG. 4 illustrates a diagram of a scenario where the present application may be implemented. A network device 102 (e.g., gNB) communicates with an amount of (e.g. one or more) user equipments (UEs), where only UE 104 is shown as an example. The UE 104 also has an SL connection with a plurality of UEs 106, respectively.

Some basic ideas of the present disclosure are the following:
The network device can allocate one or more resources for a HARQ acknowledgement, where the one or more resources may be time compensated for
LBT delays occurring during the SL-U transmission and/or during a transmission of the HARQ acknowledgement.
Resources for an SL HARQ acknowledgement may be allocated to the UE by the network device before the resources of SL transmissions are allocated to the UE.
Resources for the SL HARQ acknowledgement may be allocated to the UE by the network device when the resources of SL transmissions are allocated to the UE.
After the resources of SL transmissions are allocated to the UE, the network device may allocate the resources for the SL HARQ acknowledgement to the UE upon reception of a request message (e.g. same as described in “Example 1” later) from the UE.
The resources for the SL HARQ acknowledgement may be one or more of, or a combination of, the following: one or more PUCCH resources; or one or more PUSCH resources.
The resources for the SL HARQ acknowledgement may be decided by the network device.
The transmitting UE may generate the HARQ acknowledgement for transmitting to the network device by itself if it does not receive the HARQ acknowledgement within a configured time period.
The receiving UE may use other available resource for transmitting the HARQ acknowledgement to the transmitting UE if no PSFCH resource is available.

In the below embodiments, it is assumed that the transmitting UE adopts mode 1 SL resource allocation unless otherwise declared.

The embodiments are aiming to provide various ways for the transmitting UE to timely transmit an SL HARQ acknowledgement to the network device, so as to minimize negative impact on QoS performance of services due to LBT delays.

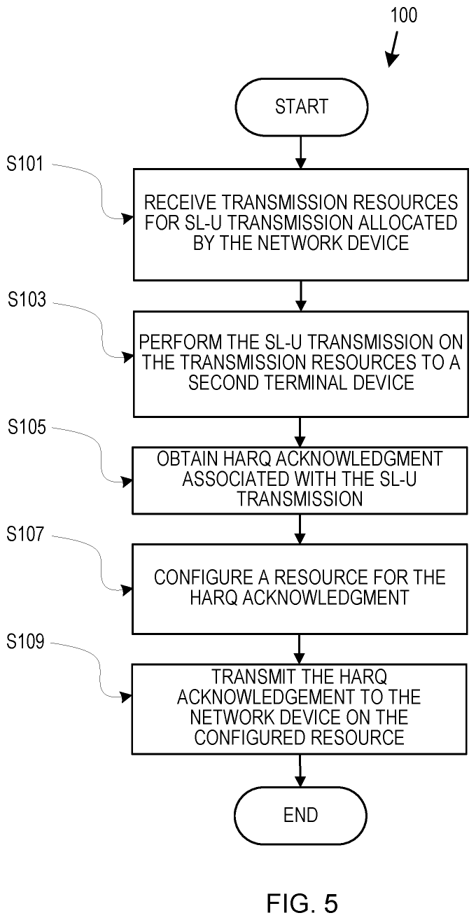

Hereinafter, a method 100 for SL transmission on an SL-U, performed by a first terminal device according to an exemplary embodiment of the present disclosure, will be described with reference to FIG. 5.

As shown in FIG. 5, the method 100 may include at least steps S101, S103, S105, S107 and S109. The steps S101, S103, S105, S107 and S109 may be performed in a case where a first terminal device (e.g., UE 104) is served by a network device (e.g., gNB 102) and has at least one SL connection with another, second terminal device (e.g., UE 106). The method 100 may be performed at the first terminal device, e.g., UE 104.

In an exemplary embodiment, in step S101, the first terminal device 104 receives transmission resources for an SL-U transmission allocated by the network device 102 to the first terminal device 104. Then, in step S103, the first terminal device 104 performs the SL-U transmission on the transmission resources to a different, second terminal device, e.g., UE 106. In step S105, the first terminal device 104 obtains a HARQ acknowledgment associated with the SL-U transmission, and configures a resource for the HARQ acknowledgment in step S107. At the end, in step S109, the first terminal device 104 transmits the HARQ acknowledgement to the network device 102 on the configured resource. The configured resource is time compensated for LBT delays occurring during the SL-U transmission and/or during a transmission of the HARQ acknowledgement.

Herein, “LBT delays” can mean delays occurring due to LBT operations and/or LBT failures. Since the configured resource, i.e., the resource for transmitting the HARQ acknowledgement, is time compensated for LBT delays, the first terminal device 104 can use the configured resource to transmit the HARQ acknowledgement to the network device 102 even if LBT failures occur during the transmission of the HARQ acknowledgement from the second terminal device 106 to the first terminal device 104, or during the transmission of the HARQ acknowledgement from the first terminal device 104 to the network device 102, or during the SL-U transmission from the first terminal device 104 to the second terminal device 106, or if LBT delays occur due to the LBT operations happening in finding opportunities to transmit the HARQ acknowledgement.

In an exemplary embodiment, in step S107, the resource for the HARQ acknowledgement may be configured as one or more resources allocated by the network device 102 to the first terminal device 104.

In an exemplary embodiment, the one or more resources allocated by the network device 102 to the first terminal device 104 may comprise one or more of:
one or more resources allocated by the network device to the first terminal device before receiving the transmission resources allocated to the first terminal device;
one or more resources allocated by the network device to the first terminal device upon receiving the transmission resources allocated to the first terminal device; and
one or more resources allocated by the network device to the first terminal device after receiving the transmission resources allocated to the terminal device.

That is, the resource for the HARQ acknowledgement may be that pre-configured by the network device 102 to the first terminal device 104, or that configured by the network device 102 to the first terminal device 104 along with the SL grant for the SL-U transmission, or even that configured by the network device 102 to the first terminal device 104 when there is such a HARQ acknowledgement to be transmitted.

In an exemplary embodiment, the one or more resources allocated by the network device 102 to the first terminal device 104 after receiving the transmission resources allocated to the first terminal device may be allocated by the network device in response to a request transmitted from the first terminal device 104 to the network device 102. For example, since there may be LBT delays in transmitting the HARQ acknowledgement, the network device 102 may not pre-configure resources for transmitting the HARQ acknowledgement, and may configures the resource upon request from the first terminal device 104. The first terminal device 104 may request the network device 102 for resources to transmit the HARQ acknowledgement when there is a HARQ acknowledgement to be transmitted.

In an exemplary embodiment, step S107 of configuring a resource for the HARQ acknowledgement may comprise a step of finding available resource in allocated resources for transmitting the HARQ acknowledgement, a step of transmitting a request to the network device in response to finding no available resource, and a step of receiving one or more resources allocated by the network device to the first terminal device in response to the request. For example, the network device 102 may pre-configure or configure the resource for the HARQ acknowledgement along with the SL grant resources for transmitting the HARQ acknowledgement. The first terminal device 104, when getting ready to transmit the HARQ acknowledgement, may find that the pre-configured or configured resources are not available due to the LBT delays. The first terminal device 104 may request the network device 102 for resources to transmit the HARQ acknowledgement.

In an exemplary embodiment, the request may be a Scheduling Request (SR) or a random access preamble for triggering a Random Access Channel (RACH) procedure. For example, the first terminal device 104 may trigger an SR for requesting PUSCH resources if there are not any (i.e. if there are no) resources available for transmitting the HARQ acknowledgement. A specific PUCCH SR resource/SR configuration may be configured to the first terminal device 104 for requesting PUSCH resources for the HARQ acknowledgement. Upon reception of the SR, the network device 102 may assign a UL grant to the first terminal device 104. As another example, the first terminal device 104 may trigger a RACH procedure for requesting PUSCH resources if there are not any (i.e. if there are no) resources available for transmitting the HARQ acknowledgement. A specific RACH resource/RACH configuration may be configured to the first terminal device 104 for requesting PUSCH resources for the HARQ acknowledgement. Upon reception of the RACH, the network device 102 may assign a UL grant to the first terminal device 104.

The RACH resource may be a preamble, RACH occasion (RO) in frequency domain or time domain.

In an exemplary embodiment, the configured resource may be one or more of, or a combination of, the following:
one or more PUCCH resources; and
one or more PUSCH resources.

In an exemplary embodiment, the network device 102 may (pre-)configure one or more resources for the first terminal device 104, and the one or more resources may be PUCCH or PUSCH resources.

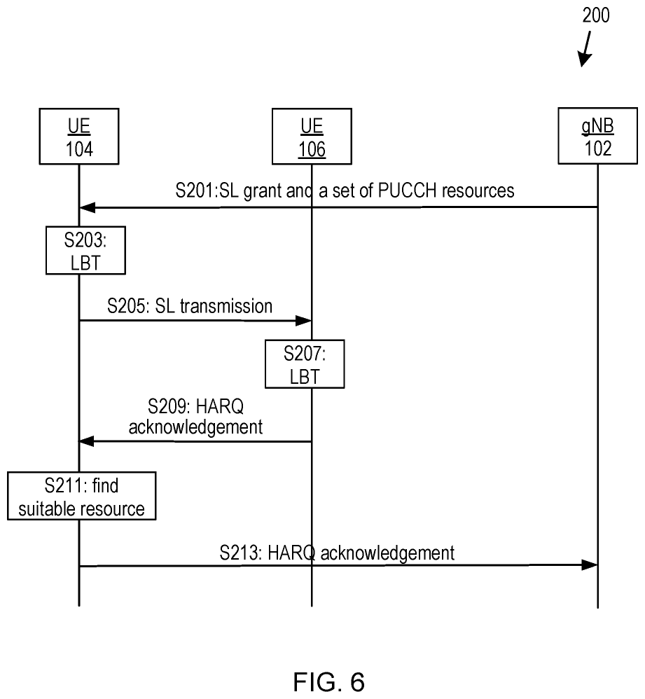

In an exemplary embodiment, the one or more resources allocated by the network device 102 to the first terminal device 104 may comprise resources that are spread in the time domain. By spreading the configured resources in the time domain, the first terminal device 104 may find available resources for transmitting the HARQ acknowledgement even if there may be different delays occurring during the transmission of the HARQ acknowledgement or during the SL-U transmission (which may also cause delays in transmitting the HARQ acknowledgement). FIG. 6 illustrates an example 200 in which the present disclosure may be implemented. As shown, when the network device 102 assigns an SL grant on an unlicensed band to the first terminal device 104 using Mode 1 resource allocation in step S201, the network device 102 may signal a set of PUCCH resources to the first terminal device 104. Those PUCCH resources can be spreading in the time domain. Upon reception of the SL grant, in step S203, the first terminal device 104 may perform an LBT operation before occupying the SL channel. After a successful LBT, in step S205, the first terminal device 104 may initiate the corresponding SL transmission on the unlicensed band to one or multiple intended SL terminal devices (for example, second terminal device 106) in the proximity. When the SL transmission finishes, the second terminal device 106 performs LBT in step S207. After a successful LBT, the second terminal device 106 can then occupy the channel for transmitting the HARQ acknowledgement in step S209. As soon as the first terminal device 104 has received at least one SL HARQ acknowledgement from the intended SL terminal devices (for example, second terminal device 106), the first terminal device 104 may choose one proper PUCCH resource from the set of PUCCH resources in step S211 and may transmit the SL HARQ acknowledgement to the network device 102 in step S213. Between the selected PUCCH resource and the time when the first terminal device 104 has received the SL HARQ acknowledgment, there can be a predefined (or sufficient) gap period, which allows the first terminal device 104 to process the SL HARQ acknowledgement and prepare transmission on the PUCCH.

In an exemplary embodiment, a set of resources may be pre-configured from the network device 102 to the first terminal device 104, and the one or more resources allocated by the network device 102 to the first terminal device 104 may comprise resources indicated by indices of resources in the set of resources. For example, a configuration (e.g. detailed configuration) of an array of PUCCH/PUSCH resources (e.g., locations in frequency domain and time domain) may be already configured to the first terminal device 104 by the network device 102, such as via RRC signaling (e.g., when the connection to the network device 102 is setup) or preconfigured to the first terminal device 104. Thus, when the network device 102 later signals an SL grant to the first terminal device 104 via Mode 1 resource allocation, it is sufficient for the network device 102 to signal the first terminal device 104 of indices or a bitmap indicating the PUCCH/PUSCH resources assigned to the first terminal device 104 among the configured/preconfigured array of PUCCH resources.

In an exemplary embodiment, the one or more resources allocated by the network device 102 to the first terminal device 104 may be indicated from the network device using one or more of the following signaling:
Radio Resource Control (RRC) signaling;
Medium Access Control (MAC) Control Element (CE); and
L1 signaling.

In case of L1 signaling, new fields may be introduced in the DCI to indicate a set of PUCCH/PUSCH resources (i.e., more than 2 resources). Alternatively, existing fields in the DCI may be repurposed to indicate a set of PUCCH/PUSCH resources. Accordingly, a new DCI format may be defined. In an example, new fields may be added to the DCI format 3_0 and/or the DCI format 3_1. The new fields may be PUCCH/PUSCH resource indicators.

In case of MAC Control Element (MAC CE) based signaling, a new MAC CE may be defined. Alternatively, an existing MAC CE may be reused for indicating a set of PUCCH/PUSCH resources.

In case of RRC signaling, new information elements may be defined for indicating a set of PUCCH/PUSCH resources.

In order to limit the size of new fields, a bitmap field may be defined which contains multiple bits. For example, each bit may represent a PUCCH/PUSCH resource among the configured/preconfigured array of PUCCH/PUSCH resources. The bit with a value of ‘0’ can mean that the corresponding resource is not assigned to the first terminal device 104, while a value of ‘1’ can mean that the corresponding resource is assigned to the first terminal device 104.

In an exemplary embodiment, in step S107 of configuring a resource for a HARQ acknowledgement, if an UL grant is available at the first terminal device 104, the first terminal device 104 may use a Physical Uplink Shared Channel (PUSCH) resource of the UL grant as the configured resource.

In an exemplary embodiment, the first terminal device 104 may use a PUSCH of the UL grant by:
mapping the HARQ acknowledgement on the PUSCH resource if there is neither any Medium Access Control (MAC) Service Data Unit (SDU) nor any MAC CE to be transmitted on the PUSCH resource; or
multiplexing the SL HARQ acknowledgement and a MAC Service Data Unit (MAC SDU) or a MAC CE on the PUSCH resource if there is such a MAC SDU or MAC CE to be transmitted on the PUSCH resource.

In an example (referred to earlier as “Example 1”), the first terminal device 104 may have received few resources (e.g. PUCCH resources) for the HARQ acknowledgement along with an SL grant from the network device 102. In this example, if the HARQ acknowledgement is delayed due to LBT failures on the unlicensed band, the first terminal device 104 therefore misses the received resources. In order to forward the SL HARQ acknowledgement to the network device 102 on time, although the HARQ acknowledgement may be delayed by LBT failures on the unlicensed band, if the first terminal device 104 has a UL grant (i.e., configured grant or dynamic grant) available, the first terminal device 104 may determine to map/multiplex the HARQ acknowledgement on PUSCH using the UL grant. The PUSCH transmission can carry the HARQ acknowledgement even if there is no PUCCH resource available. In this case, the PUSCH may carry only the HARQ acknowledgement, without containing any MAC SDU or MAC CE. It is also possible that the PUSCH carries both the SL HARQ acknowledgement and also some MAC SDUs, and/or MAC CEs.

In an exemplary embodiment, when the first terminal device 104 has obtained a UL grant for a HARQ acknowledgement, the UL grant may not be allowed to be skipped by the first terminal device 104 regardless of whether the first terminal device 104 is configured with or allowed to apply UL grant skipping. In other words, the first terminal device 104 may build a MAC protocol data unit (PDU) containing only the SL HARQ acknowledgement and transmit the PDU on the PUSCH using the UL grant. Alternatively, whether to skip UL grant when the first terminal device 104 has only the HARQ acknowledgement available for transmission may be configured to the first terminal device 104 by the network device 102.

In an exemplary embodiment, step S105 of obtaining the HARQ acknowledgment associated with the SL-U transmission may comprise a step of receiving the HARQ acknowledgment from the second terminal device 106. That is, the second terminal device 106 may generate and transmit the HARQ acknowledgment to the first terminal device 104 for transmitting to the network device 102.

In an exemplary embodiment, step S105 of obtaining the HARQ acknowledgment associated with the SL-U transmission may comprise a step of generating the HARQ acknowledgment if no HARQ acknowledgement is received for a predefined period. As an example, after an SL transmission using an SL grant by the first terminal device 104, it may be that the first terminal device 104 cannot receive any HARQ acknowledgement from any receiving terminal device (there may be one or multiple receiving terminal devices depending on cast type) although HARQ feedback has been enabled for the SL transmission. The first terminal device 104 may determine to generate an SL HARQ acknowledgement by itself and send to the network device 102. The first terminal device 104 may generate a positive HARQ acknowledgment as the HARQ acknowledgment if no transmission resources for SL-U retransmission are required, and generate a negative HARQ acknowledgment as the HARQ acknowledgment if transmission resources for SL-U retransmission are required. In an example, the first terminal device 104 may start a timer after the starting of the SL-U transmission, stop the timer when receiving the HARQ acknowledgment from the second terminal device 106, and generate the HARQ acknowledgment when the timer expires. The first terminal device 104 may also restart the timer every time (when) the first terminal device 104 has performed a retransmission. The timer expiring can mean that no HARQ acknowledgment is received from the second terminal device 106 for a time period.

In an exemplary embodiment, the first terminal device 104 may be configured with a multi-connection with the network device 102, and step S107 of configuring a resource for the HARQ acknowledgment may comprise a step of using an available resource on a connection different from the connection on which the transmission resources are received as the configured resource. For example, in an example in which the first terminal device 104 is configured with multi-connections (e.g., via carrier aggregation or dual connectivity) in the Uu interface, the first terminal device 104 may determine to use whatever available PUCCH resource or whatever available PUSCH resource in any other serving cell or carrier to transmit the SL HARQ acknowledgement.

In the present disclosure, various ways for the (first) terminal device to timely provide a HARQ acknowledgement to the network device are provided, for example enabling the terminal device to have additional resources for transmitting the HARQ acknowledgement (for example, by a request) even if there is no available resource for transmitting the HARQ acknowledgement, providing resources spreading in time domain so that the terminal device may choose appropriate resources for transmitting the HARQ acknowledgement even if LBT delays occur, or having the terminal device generate the HARQ acknowledgement by itself if no HARQ acknowledgement is received.

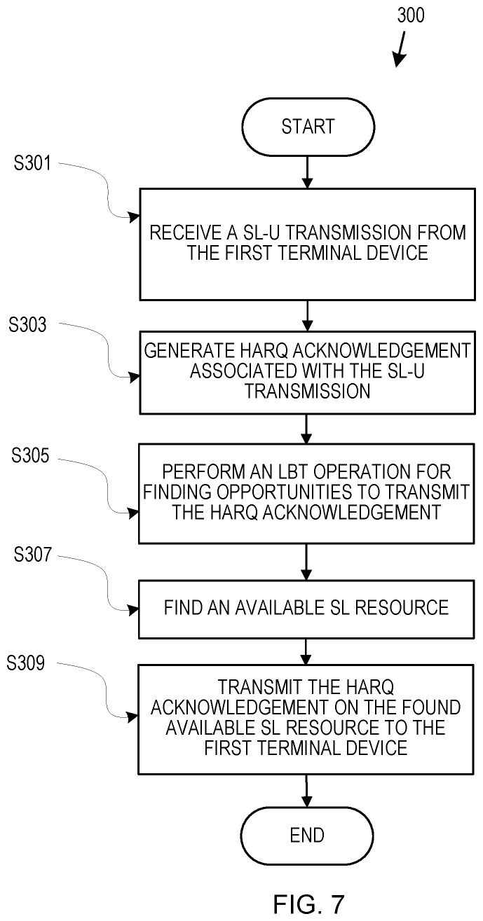

Hereinafter, a method 300 for Side Link (SL) transmission on an Unlicensed band (SL-U), performed by a second terminal device according to an exemplary embodiment of the present disclosure, will be described with reference to FIG. 7.

As shown in FIG. 7, the method 300 may include at least steps S301, S303, S305, S307 and S309. The steps S301, S303, S305, S307 and S309 may be performed in a case where a first terminal device (e.g., UE 104) is served by a network device (e.g., gNB 102) and has at least one SL connection with another, second terminal device (e.g., UE 106). The method 300 may be performed at the second terminal device, e.g., UE 106.

In an exemplary embodiment, in step S301, the second terminal device 106 receives an SL-U transmission from the first terminal device 104. After the SL-U transmission finishes, in step S303, the second terminal device 106 generates a HARQ acknowledgement associated with the SL-U transmission. Then, in step S305, the second terminal device 106 performs an LBT operation for finding opportunities to transmit the HARQ acknowledgement. If the LBT operation is successful but no Physical Sidelink Feedback Channel (PSFCH) resource is available within a given time period, the second terminal device 106 finds an available SL resource in step S307 and then, in step S309, transmits the HARQ acknowledgement on the found available SL resource to the first terminal device 104.

In an exemplary embodiment, in step S307, the second terminal device 106 may find available SL resources for a Physical Sidelink Shared Channel (PSSCH) or Physical Sidelink Common Control Channel (PSCCH) transmission towards the first terminal device 104 within that time period and may then, in step S309, transmit the HARQ acknowledgement by multiplexing the HARQ acknowledgement in the PSSCH or PSCCH transmission towards the first terminal device. For example, when the second terminal device 106 has received an SL transmission on an unlicensed band, if the second terminal device 106 is required to provide an SL HARQ acknowledgement to the transmitting terminal device, the second terminal device 106 may perform LBT operation prior to the transmission of the SL HARQ acknowledgement. The second terminal device 106 may be subject to LBT failures. This may delay transmission of the SL HARQ acknowledgement. If the second terminal device 106 cannot find suitable PSFCH resources within a given time period (e.g., a maximum time period during which the second terminal device 106 has to provide the SL HARQ acknowledgement), the second terminal device 106 may choose to multiplex the SL HARQ acknowledgement in a PSSCH or PSCCH transmission towards the transmitting terminal device if the second terminal device 106 can manage to find SL resources for the PSSCH or the PSCCH transmission within that time period. In this way, more transmission opportunities can be provided to the second terminal device 106 for the SL HARQ acknowledgement.

In an exemplary embodiment, in step S307, the second terminal device 106 may find available SL resources on a connection different from the connection on which the SL-U transmission is received and then, in step S309, may transmit the HARQ acknowledgement on the available SL resources on the different connection. For example, the second terminal device 106 may be configured with multi-connections (e.g., via carrier aggregation or dual connectivity) in the SL connections. In such a case, if there are multiple SL carriers available/configured between the second terminal device 106 and the transmitting terminal device, and if an SL HARQ acknowledgement is subject to LBT failures on an SL carrier (e.g., SL carrier 1), the SL HARQ acknowledgement may be transmitted on another SL carrier (e.g., SL carrier 2).

In the present disclosure, various ways for the (second) terminal device to timely provide a HARQ acknowledgement are provided, for example enabling the second terminal device to find other available resources for transmitting the HARQ acknowledgement even if there is no suitable PSFCH resources, so that the first terminal device may receive the HARQ acknowledgement in time and feedback the HARQ acknowledgement to the network device.

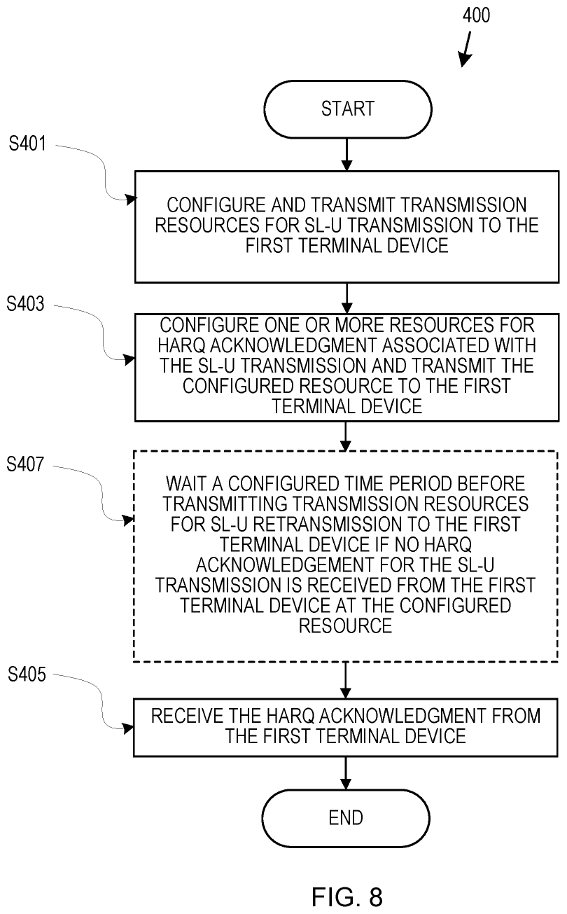

Hereinafter, a method 400 for Side Link (SL) transmission on an Unlicensed band (SL-U), performed by a network device according to an exemplary embodiment of the present disclosure, will be described with reference to FIG. 8.

As shown in FIG. 8, the method 400 may include at least steps S401, S403, and S405. The steps S401, S403, and S405 may be performed where a first terminal device (e.g., UE 104) is served by a network device (e.g., gNB 102) and has at least one SL connection with another, second terminal device (e.g., UE 106). The method 400 may be performed at the network device, e.g., gNB 102.

In an exemplary embodiment, in step S401, the network device 102 configures and transmits transmission resources for SL-U transmission to the first terminal device 104 to perform the SL-U transmission. The network device 102 may also configure one or more resources for the HARQ acknowledgment associated with the SL-U transmission and transmit the configured resource to the first terminal device in step S403. Then, in step S405, the network device 102 receives the HARQ acknowledgment from the first terminal device 104. The configured resource is time compensated for Listen Before Talk (LBT) delays occurring during the SL-U transmission and/or during a transmission of the HARQ acknowledgement.

Herein, “LBT delays” can mean delays occurring due to LBT operations and/or LBT failures.

In an exemplary embodiment, step S403 of transmitting the configured resource may be performed before transmitting the transmission resources; or upon transmitting the transmission resources; or after transmitting the transmission resources.

That is, the resource for the HARQ acknowledgement may be that pre-configured by the network device 102 to the first terminal device 104, or that configured by the network device 102 to the first terminal device 104 along with the SL grant for the SL-U transmission, or even that configured by the network device 102 to the first terminal device 104 when there is such a HARQ acknowledgement to be transmitted at the first terminal device 104.

In an exemplary embodiment, step S403 of transmitting the configured resource may comprise a step of receiving a request from the first terminal device, and a step of allocating and transmitting one or more resources to the first terminal device 104. For example, since there may be LBT delays in transmitting the HARQ acknowledgement, the network device 102 may not pre-configure resources for transmitting the HARQ acknowledgement, and may configure the resource upon request from the first terminal device 104. The first terminal device 104 may request the network device 102 for resources to transmit the HARQ acknowledgement when there is a HARQ acknowledgement to be transmitted. As another example, the network device 102 may pre-configure or configure the resource for the HARQ acknowledgement along with the SL grant resources for transmitting the HARQ acknowledgement. The first terminal device 104, when getting ready to transmit the HARQ acknowledgement, may find that the pre-configured or configured resources are not available due to the LBT delays. The first terminal device 104 may request the network device 102 for resources to transmit the HARQ acknowledgement.

In an exemplary embodiment, the request may be a Scheduling Request (SR) or a random access preamble for triggering a Random Access Channel (RACH) procedure. For example, the first terminal device 104 may trigger an SR for requesting PUSCH resources if there are not any (i.e. if there are no) resources available for transmitting the HARQ acknowledgement. A specific PUCCH SR resource/SR configuration may be configured to the first terminal device 104 for requesting PUSCH resources for the HARQ acknowledgement. Upon reception of the SR, the network device 102 may assign a UL grant to the first terminal device 104. As another example, the first terminal device 104 may trigger a RACH procedure for requesting PUSCH resources if there are not any (i.e. if there are no) resources available for transmitting the HARQ acknowledgement. A specific RACH resource/RACH configuration may be configured to the first terminal device 104 for requesting PUSCH resources for the HARQ acknowledgement. Upon reception of the RACH, the network device 102 may assign a UL grant to the first terminal device 104. The RACH resource may be a preamble, RO in frequency domain or time domain.

In an exemplary embodiment, step S403 of configuring one or more resources for the HARQ acknowledgment associated with the SL-U transmission and transmitting the configured resource to the first terminal device may comprise: deciding one of a PUCCH resource or a Physical Uplink Shared Channel (PUSCH) resource to be configured; and configuring the decided resource to the first terminal device.

In an exemplary embodiment, deciding one of a PUCCH resource or a PUSCH resource to be configured may comprise deciding one of a PUCCH resource or a PUSCH resource depending one of the following conditions:
deciding to configure a PUSCH resource if there is no free PUCCH resource;
deciding to configure a PUCCH resource if there is no free PUSCH resource;
deciding to configure a PUCCH resource if there are both a free PUCCH resource and a free PUSCH resource and a high transmission reliability for the HARQ acknowledgement is required; and
deciding to configure a PUSCH resource if there are both a free PUCCH resource and a free PUSCH resource and the HARQ acknowledgement does not require a high transmission reliability.

In an exemplary embodiment, the configured resource may be one or more of, or a combination of, the following:
one or more PUCCH resources; and
one or more PUSCH resources.

In an exemplary embodiment, the network device 102 may (pre-)configure one or more resources for the first terminal device 104, and the one or more resources may be PUCCH or PUSCH resources.

In an exemplary embodiment, step S403 of configuring one or more resources for the HARQ acknowledgment associated with the SL-U transmission and transmitting the configured resource to the first terminal device may comprise: pre-configuring a set of resources to the first terminal device, and transmitting the configured resource by indicating resources to the first terminal device by indices of resources in the set of resources. For example, configuration (e.g. detailed configuration) of an array of PUCCH/PUSCH resources (e.g., locations in frequency domain and time domain) may be already configured to the first terminal device 104 by the network device 102 via RRC signaling (e.g., when the connection to the network device 102 is setup) or preconfigured to the first terminal device 104. Thus, when the network device 102 later signals an SL grant to the first terminal device 104 via Mode 1 resource allocation, it can be sufficient for the network device 102 to signal the first terminal device 104 of indices or a bitmap indicating the PUCCH/PUSCH resources assigned to the first terminal device 104 among the configured/preconfigured array of PUCCH/PUSCH resources.

In an exemplary embodiment, the network device 102 may use one or more of the following signaling to transmit the configured resource:
Radio Resource Control (RRC) signaling;
Medium Access Control (MAC) Control Element (CE); and
L1 signaling.

In case of L1 signaling, new fields may be introduced in the DCI to indicate a set of PUCCH/PUSCH resources (i.e., more than 2 resources). Alternatively, existing fields in the DCI may be repurposed to indicate a set of PUCCH/PUSCH resources. Accordingly, a new DCI format may be defined. In an example, new fields may be added to the DCI format 3_0 and/or the DCI format 3_1. The new fields may be PUCCH/PUSCH resource indicators.

In case of MAC CE based signaling, a new MAC CE may be defined. Alternatively, an existing MAC CE may be reused for indicating a set of PUCCH/PUSCH resources.

In case of RRC signaling, new information elements may be defined for indicating a set of PUCCH/PUSCH resources.

In order to limit the size of new fields, a bitmap field may be defined which contains multiple bits. For example, each bit may represent a PUCCH/PUSCH resource among the configured/preconfigured array of PUCCH/PUSCH resources. The bit with a value ‘0’ can mean that the corresponding resource is not assigned to the first terminal device 104, while a value of ‘1’ can mean that the corresponding resource is assigned to the first terminal device 104.

In an exemplary embodiment, the method 400 may further comprise step S407 of waiting a configured time period before transmitting transmission resources for SL-U retransmission to the first terminal device if no HARQ acknowledgement for the SL-U transmission is received from the first terminal device at the configured resource. For example, when the network device 102 has assigned an SL grant on an unlicensed band to the first terminal device 104, if the network device 102 has also assigned a PUCCH resource to the first terminal device 104 for forwarding an SL HARQ acknowledgement, the network device 102 may not immediately schedule SL grants for retransmissions to the first terminal device 104 when the network device 102 is not able to receive/detect any transmission on the PUCCH resource. The network device 102 can wait a while (optionally, a configured time period) to see if the network device 102 may receive the expected SL HARQ acknowledgement on the subsequent PUSCH or PUCCH resource. In this way, the network device 102 can avoid assigning unnecessary SL grants to the first terminal device 104, thereby reducing resource wastage.

In an additional embodiment, when the network device 102 determines to assign an SL grant to the transmitting UE (e.g., terminal device 104) using Mode 1 resource allocation, the network device 102 may consider the knowledge that the SL HARQ acknowledgement may be delayed due to LBT failures on the SL, so that the network device 102 may assign a PUCCH/PUSCH resource which has a sufficient gap from the end of the SL transmission, allowing the receiving UE (e.g., terminal device 106) to perform LBT operation multiple times on the SL. In this case, the PUCCH/PUSCH resource may be still available in the time domain even if the receiving UE (e.g., terminal device 106) has provided the SL HARQ acknowledgement somewhat late due to LBT failure.

For this additional embodiment, there may be several ways for the network device 102 to obtain the knowledge.

In an example, the terminal device may provide the information on whether SL transmissions may be subject to LBT failures in recent periods to the network device 102.

In an example, the network device 102 may obtain the knowledge by itself. The network device 102 may be able to sense the SL channels. The network device 102 may be also able to measure congestion status, or interference status of the SL links. Based on which, the network device 102 can learn that the terminal device may be subject to LBT failure on the SL channels.

In case the Uu link is also on an unlicensed band, the UE (e.g., terminal device 104 and/or terminal device 106 if the terminal device 106 needs to perform transmission towards the gNB) may also need to perform LBT prior to the PUCCH/PUSCH transmission. If the Uu link is also in an unlicensed band, when the network device 102 considers the information on LBT operation, the network device 102 may need to consider that the terminal device may experience LBT failure on either the Uu link or the SL, so that the network device 102 may assign resources in the time domain with sufficient gap period allowing the terminal device to perform LBT operation.

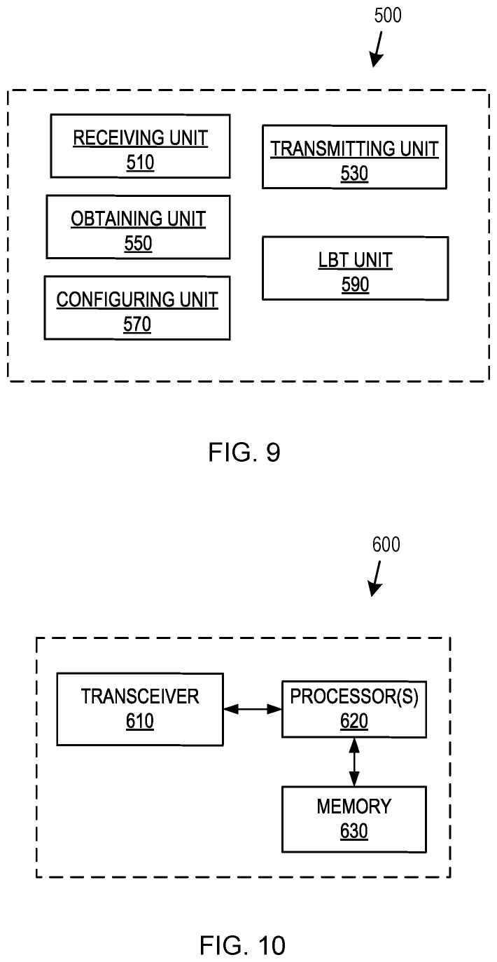

Correspondingly to the methods 100 and 300 as described above, a terminal device is provided. FIG. 9 is a block diagram of a terminal device 500 according to an embodiment of the present disclosure.

In an example, the terminal device 500 may be the first terminal device 104 described in conjunction with FIGS. 5-8.

As shown in FIG. 9, the terminal device 500 comprises (e.g. includes) a receiving unit 510 configured to receive transmission resources for SL-U transmission allocated by the network device 102 to the terminal device 500, a transmitting unit 530 configured to perform the SL-U transmission on the transmission resources to a peer terminal device, an obtaining unit 550 configured to obtain a HARQ acknowledgment associated with the SL-U transmission, and a configuring unit 570 configured to configure a resource for the HARQ acknowledgment. The transmitting unit 530 is further configured to transmit the HARQ acknowledgement to the network device 102 on the configured resource. The configured resource configured by the configuring unit 570 is time compensated for LBT delays occurring during the SL-U transmission and/or during a transmission of the HARQ acknowledgement.

Herein, “LBT delays” can mean delays occurring due to LBT operations and/or LBT failures.

Since the configured resource, i.e., the resource for transmitting the HARQ acknowledgement, is time compensated for LBT delays, the terminal device 500 can use the configured resource to transmit the HARQ acknowledgement to the network device 102 even if LBT failures occur during the transmission of the HARQ acknowledgement from the peer terminal device to the terminal device 500, or during the transmission of the HARQ acknowledgement from the terminal device 500 to the network device 102, or during the SL-U transmission from the terminal device 500 to the peer terminal device, or if LBT delays occur due to the LBT operations happening in finding opportunities to transmit the HARQ acknowledgement.

In an exemplary embodiment, the configuring unit 570 may be configured to configure the resource for HARQ acknowledgement as one or more resources allocated by the network device 102 to the terminal device 500.

In an exemplary embodiment, the one or more resources allocated by the network device 102 to the terminal device 500 may comprise one or more of:
one or more resources allocated by the network device 102 to the terminal device 500 before receiving the transmission resources allocated to the terminal device 500;
one or more resources allocated by the network device 102 to the terminal device 500 upon receiving the transmission resources allocated to the terminal device 500; and
one or more resources allocated by the network device 102 to terminal device 500 after receiving the transmission resources allocated to the terminal device 500.

That is, the resource for the HARQ acknowledgement may be that pre-configured by the network device 102 to the terminal device 500, or that configured by the network device 102 to the terminal device 500 along with the SL grant for the SL-U transmission, or even that configured by the network device 102 to the terminal device 500 when there is such a HARQ acknowledgement to be transmitted at the terminal device 500.

In an exemplary embodiment, the one or more resources allocated by the network device 102 to the terminal device 500 after receiving the transmission resources allocated to the first terminal device may be allocated by the network device in response to a request transmitted from the transmitting unit 530 of the terminal device 500 to the network device 102. For example, since there may be LBT delays in transmitting the HARQ acknowledgement, the network device 102 may not pre-configure resources for transmitting the HARQ acknowledgement, and may configure the resource upon request from the terminal device 500. The terminal device 500 may request the network device 102 for resources to transmit the HARQ acknowledgement when there is a HARQ acknowledgement to be transmitted.

In an exemplary embodiment, the configuring unit 570 may be configured to find available resource in allocated resources for transmitting the HARQ acknowledgement, the transmitting unit 530 may be configured to transmit a request to the network device in response to finding no available resource in the configuring unit 570, and the receiving unit 510 may be configured to receive one or more resources allocated by the network device to the terminal device in response to the request. For example, the network device 102 may pre-configure or configure the resource for the HARQ acknowledgement along with the SL grant resources for transmitting the HARQ acknowledgement. The terminal device 500, when getting ready to transmit the HARQ acknowledgement, may find that the pre-configured or configured resources are not available due to the LBT delays. The terminal device 500 may request the network device 102 for resources to transmit the HARQ acknowledgement.

In an exemplary embodiment, the request may be a Scheduling Request (SR) or a random access preamble for triggering a Random Access Channel (RACH) procedure. For example, the terminal device 500 may trigger an SR for requesting PUSCH resources if there are not any (i.e. if there are no) resources available for transmitting the HARQ acknowledgement. A specific PUCCH SR resource/SR configuration may be configured to the terminal device 500 for requesting PUSCH resources for the HARQ acknowledgement. Upon reception of the SR, the network device 102 may assign a UL grant to the terminal device 500. As another example, the terminal device 500 may trigger a RACH procedure for requesting PUSCH resources if there are not any (i.e. if there are no) resources available for transmitting the HARQ acknowledgement. A specific RACH resource/RACH configuration may be configured to the terminal device 500 for requesting PUSCH resources for the HARQ acknowledgement. Upon reception of the RACH, the network device 102 may assign a UL grant to the terminal device 500. The RACH resource may be a preamble, RO in frequency domain or time domain.

In an exemplary embodiment, the configured resource may be one or more of, or a combination of, the following:
one or more PUCCH resources; and
one or more PUSCH resources.

In an exemplary embodiment, the network device 102 may (pre-)configure one or more resources for the terminal device 500, and the one or more resources may be PUCCH or PUSCH resources.

In an exemplary embodiment, the one or more resources allocated by the network device 102 to the terminal device 500 may comprise resources that are spread in the time domain. By spreading the configured resources in the time domain, the terminal device 500 may find available resources for transmitting the HARQ acknowledgement even if there may be different delays occurring during the transmission of the HARQ acknowledgement or during the SL-U transmission (which may also cause delays in transmitting the HARQ acknowledgement).

In an exemplary embodiment, a set of resources may be pre-configured from the network device 102 to the terminal device 500, and the one or more resources allocated by the network device 102 to the terminal device 500 may comprise resources that are indicated by indices of resources in the set of resources. For example, configuration (e.g. detailed configuration) of an array of PUCCH/PUSCH resources (e.g., locations in frequency domain and time domain) may be already configured to the terminal device 500 by the network device 102 via RRC signaling (e.g., when the connection to the network device 102 is setup) or preconfigured to the terminal device 500. Thus, when the network device 102 later signals an SL grant to the terminal device 500 via Mode 1 resource allocation, it can be sufficient for the network device 102 to signal the terminal device 500 of indices or a bitmap indicating the PUCCH/PUSCH resources assigned to the terminal device 500 among the configured/preconfigured array of PUCCH resources.

In an exemplary embodiment, the one or more resources allocated by the network device 102 to the terminal device 500 may be indicated from the network device using one or more of the following signaling:
Radio Resource Control (RRC) signaling;
Medium Access Control (MAC) Control Element (CE); and
L1 signaling.

In case of L1 signaling, new fields may be introduced in the DCI to indicate a set of PUCCH/PUSCH resources (i.e., more than 2 resources). Alternatively, existing fields in the DCI may be repurposed to indicate a set of PUCCH/PUSCH resources. Accordingly, a new DCI format may be defined. In an example, new fields may be added to the DCI format 3_0 and/or the DCI format 3_1. The new fields may be PUCCH/PUSCH resource indicators.

In case of MAC CE based signaling, a new MAC CE may be defined. Alternatively, an existing MAC CE may be reused for indicating a set of PUCCH/PUSCH resources.

In case of RRC signaling, new information elements may be defined for indicating a set of PUCCH/PUSCH resources.

In order to limit the size of new fields, a bitmap field may be defined which contains multiple bits. For example, each bit may represent a PUCCH/PUSCH resource among the configured/preconfigured array of PUCCH/PUSCH resources. The bit with a value of ‘0’ can mean that the corresponding resource is not assigned to the terminal device 500, while a value of ‘1’ can mean that the corresponding resource is assigned to the terminal device 500.

In an exemplary embodiment, if an UL grant is available at the first terminal device, the configuring unit 570 may use a Physical Uplink Shared Channel (PUSCH) resource of the UL grant as the configured resource.

In an exemplary embodiment, the terminal device 500 may use a PUSCH of the UL grant by:
mapping the HARQ acknowledgement on the PUSCH resource if there is neither any Medium Access Control (MAC) Service Data Unit (SDU) nor any MAC CE to be transmitted on the PUSCH resource; or
multiplexing the SL HARQ acknowledgement and a MAC SDU or a MAC CE on the PUSCH resource if there is such MAC SDU or MAC CE to be transmitted on the PUSCH resource.

In an exemplary embodiment, when the terminal device 500 has obtained a UL grant for a HARQ acknowledgement, it may be that the UL grant is not allowed to be skipped by the terminal device 500 regardless of whether the terminal device 500 is configured with or allowed to apply UL grant skipping. In other words, the terminal device 500 may build a medium access control protocol data unit (MAC PDU) containing only the SL HARQ acknowledgement and transmit the PDU on the PUSCH using the UL grant. Alternatively, whether to skip UL grant when the terminal device 500 has only the HARQ acknowledgement available for transmission may be configured to the terminal device 500 by the network device 102.

In an exemplary embodiment, the obtaining unit 550 may be configured to receive the HARQ acknowledgment from the different terminal device. That is, the peer terminal device may generate and transmit the HARQ acknowledgment to the terminal device 500 for transmitting to the network device 102.

In an exemplary embodiment, the obtaining unit 550 may be configured to generate the HARQ acknowledgment if no HARQ acknowledgement is received for a predefined period. As an example, after an SL transmission using an SL grant by the terminal device 500, it may be that the terminal device 500 cannot receive any HARQ acknowledgement from any receiving terminal device (there may be one or multiple receiving terminal devices depending on cast type) although HARQ feedback has been enabled for the SL transmission. The terminal device 500 may determine to generate an SL HARQ acknowledgement by itself and send to the network device 102. The terminal device 500 may generate a positive HARQ acknowledgment as the HARQ acknowledgment if no transmission resources for SL-U retransmission are required, and generate a negative HARQ acknowledgment as the HARQ acknowledgment if transmission resources for SL-U retransmission are required. In an example, the terminal device 500 may start a timer after the starting of the SL-U transmission, stop the timer when receiving the HARQ acknowledgment from the second terminal device, and generate the HARQ acknowledgment when the timer expires. The terminal device 500 may also restart the timer every time (when) the terminal device 500 has performed a retransmission. The timer expiring can mean that no HARQ acknowledgment is received from the second terminal device for a time period.

In an exemplary embodiment, the terminal device 500 may be configured with a multi-connection with the network device 102, and the configuring unit 570 may be configured to use an available resource on a connection different from the connection on which the transmission resources are received as the configured resource. For example, in an example in which the terminal device 500 is configured with multi-connections (e.g., via carrier aggregation or dual connectivity) in the Uu interface, the configuring unit 570 of the terminal device 500 may determine to use whatever available PUCCH resource or whatever available PUSCH resource in any other serving cell or carrier to transmit the SL HARQ acknowledgement.

In an example, the terminal device 500 may be the second terminal device 106 described in conjunction with FIGS. 5-8.

In an exemplary embodiment, the receiving unit 510 may be configured to receive an SL-U transmission from the peer terminal device (for example, terminal device 104). The obtaining unit 550 may be configured to generate the HARQ acknowledgement associated with the SL-U transmission after the SL-U transmission finishes.

The terminal device 500 may further comprise an LBT unit 590 configured to perform an LBT operation for finding opportunities to transmit the HARQ acknowledgement. The configuring unit 570 may be configured to find an available SL resource if the LBT operation is successful but no Physical Sidelink Feedback Channel (PSFCH) resource is available within a given time period. The transmitting unit 530 may be configured to transmit the HARQ acknowledgement on the found available SL resource to the peer terminal device.

In an exemplary embodiment, the configuring unit 570 may be configured to find available SL resources for a Physical Sidelink Shared Channel (PSSCH) or Physical Sidelink Common Control Channel (PSCCH) transmission towards the peer terminal device within that time period, and then the transmitting unit 530 may be configured to transmit the HARQ acknowledgement by multiplexing the HARQ acknowledgement in the PSSCH or PSCCH transmission towards the peer terminal device. For example, when the terminal device 500 has received an SL transmission on an unlicensed band, if the terminal device 500 is required to provide an SL HARQ acknowledgement to the transmitting terminal device, the LBT unit 590 of the terminal device 500 may perform LBT operation prior to the transmission of the SL HARQ acknowledgement. The terminal device 500 may be subject to LBT failures. This may delay transmission of the SL HARQ acknowledgement. If the terminal device 500 cannot find suitable PSFCH resources within a given time period (i.e., a maximum time period during which the terminal device 500 has to provide the SL HARQ acknowledgement), the transmitting unit 530 of the terminal device 500 may choose to multiplex the SL HARQ acknowledgement in a PSSCH or PSCCH transmission towards the transmitting terminal device if the terminal device 500 can manage to find SL resources for the PSSCH or the PSCCH transmission within that time period. In this way, more transmission opportunities can be provided to the terminal device 500 for the SL HARQ acknowledgement.

In an exemplary embodiment, the configuring unit 570 may be configured to find available SL resources on a connection different from the connection on which the SL-U transmission is received, and then the transmitting unit 530 may be configured to transmit the HARQ acknowledgement on the available SL resources on the different connection. For example, the terminal device 500 may be configured with multi-connections (e.g., via carrier aggregation or dual connectivity) in the SL connections. In such a case, if there are multiple SL carriers available/configured between the terminal device 500 and the transmitting terminal device, and if an SL HARQ acknowledgement is subject to LBT failures on an SL carrier (e.g., SL carrier 1), the SL HARQ acknowledgement may be transmitted on another SL carrier (e.g., SL carrier 2).

The units 510-590 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIGS. 5-8.

FIG. 10 is a block diagram of a terminal device 600 according to another embodiment of the present disclosure.

The terminal device 600 comprises (e.g. includes) a transceiver 610, a processor 620 and a memory 630. The memory 630 can contain instructions executable by the processor 620 whereby the terminal device 600 is operative to perform the actions, e.g., of the procedure described earlier in conjunction with FIGS. 5-7. Particularly, the memory 630 may contain instructions executable by the processor 620 whereby the terminal device 600 is operative to perform SL-U transmission.

In an exemplary embodiment, the memory 630 may contain instructions executable by the processor 620 whereby the transceiver 610 can be operative to receive transmission resources for SL-U transmission allocated by the network device 102 to the terminal device 600, perform the SL-U transmission on the transmission resources to a peer terminal device, obtain the HARQ acknowledgment associated with the SL-U transmission, configure a resource for the HARQ acknowledgment, and transmit the HARQ acknowledgement to the network device 102 on the configured resource. The configured resource is time compensated for LBT delays occurring during the SL-U transmission and/or during a transmission of the HARQ acknowledgement.

Since the configured resource, i.e., the resource for transmitting the HARQ acknowledgement, is time compensated for LBT delays, the terminal device 600 can use the configured resource to transmit the HARQ acknowledgement to the network device 102 even if LBT failures occur during the transmission of the HARQ acknowledgement from the peer terminal device to the terminal device 600, or during the transmission of the HARQ acknowledgement from the terminal device 600 to the network device 102, or during the SL-U transmission from the terminal device 600 to the peer terminal device, or if LBT delays occur due to the LBT operations happening in finding opportunities to transmit the HARQ acknowledgement.

In an exemplary embodiment, the memory 630 may contain instructions executable by the processor 620 whereby the terminal device 600 is further operative to configure the resource for the HARQ acknowledgement as one or more resources allocated by the network device 102 to the terminal device 600.

In an exemplary embodiment, the one or more resources allocated by the network device 102 to the terminal device 600 may comprise one or more of:
one or more resources allocated by the network device to the terminal device before receiving the transmission resources allocated to the terminal device;
one or more resources allocated by the network device to the terminal device upon receiving the transmission resources allocated to the terminal device; and
one or more resources allocated by the network device to the terminal device after receiving the transmission resources allocated to the terminal device.

That is, the resource for the HARQ acknowledgement may be that pre-configured by the network device 102 to the terminal device 600, or that configured by the network device 102 to the terminal device 600 along with the SL grant for the SL-U transmission, or even that configured by the network device 102 to the terminal device 600 when there is such a HARQ acknowledgement to be transmitted at the terminal device 600.

In an exemplary embodiment, the one or more resources allocated by the network device 102 to the terminal device 600 after receiving the transmission resources allocated to the first terminal device may be allocated by the network device in response to a request transmitted from the terminal device 600 to the network device 102. For example, since there may be LBT delays in transmitting the HARQ acknowledgement, the network device 102 may not pre-configure resources for transmitting the HARQ acknowledgement, and may configure the resource upon request from the terminal device 600. The memory 630 may contain instructions executable by the processor 620 whereby the terminal device 600 may be further operative to transmit a request to the network device 102 for resources to transmit the HARQ acknowledgement when there is a HARQ acknowledgement to be transmitted.

In an exemplary embodiment, the memory 630 may contain instructions executable by the processor 620 whereby the terminal device 600 may be further operative to find available resource in allocated resources for transmitting the HARQ acknowledgement, transmit a request to the network device in response to finding no available resource, and receive one or more resources allocated by the network device to the terminal device in response to the request.

In an exemplary embodiment, the request may be a Scheduling Request (SR) or a random access preamble for triggering a Random Access Channel (RACH) procedure. For example, the terminal device 600 may trigger an SR for requesting PUSCH resources if there are not any (i.e. if there are no) resources available for transmitting the HARQ acknowledgement. A specific PUCCH SR resource/SR configuration may be configured to the terminal device 600 for requesting PUSCH resources for the HARQ acknowledgement. Upon reception of the SR, the network device 102 may assign a UL grant to the terminal device 600. As another example, the terminal device 600 may trigger a RACH procedure for requesting PUSCH resources if there are not any (i.e. if there are no) resources available for transmitting the HARQ acknowledgement. A specific RACH resource/RACH configuration may be configured to the terminal device 600 for requesting PUSCH resources for the HARQ acknowledgement. Upon reception of the RACH, the network device 102 may assign a UL grant to the terminal device 600. The RACH resource may be a preamble, RO in frequency domain or time domain.

In an exemplary embodiment, the configured resource may be one or more of, or a combination of, the following:
one or more PUCCH resources; and
one or more PUSCH resources.

In an exemplary embodiment, the network device 102 may (pre-)configure one or more resources for the terminal device 600, and the one or more resources may be PUCCH or PUSCH resources.

In an exemplary embodiment, the one or more resources allocated by the network device 102 to the terminal device 600 may comprise resources that are spread in the time domain. By spreading the configured resources in the time domain, the terminal device 600 may find available resources for transmitting the HARQ acknowledgement even if there may be different delays occurring during the transmission of the HARQ acknowledgement or during the SL-U transmission (which may also cause delays in transmitting the HARQ acknowledgement).

In an exemplary embodiment, a set of resources may be pre-configured from the network device 102 to the terminal device 600, and the one or more resources allocated by the network device 102 to the terminal device 600 may comprise resources that are indicated by indices of resources in the set of resources. For example, configuration (e.g. detailed configuration) of an array of PUCCH/PUSCH resources (e.g., locations in frequency domain and time domain) may be already configured to the terminal device 600 by the network device 102 via RRC signaling (e.g., when the connection to the network device 102 is setup) or preconfigured to the terminal device 600. Thus, when the network device 102 later signals an SL grant to the terminal device 600 via Mode 1 resource allocation, it can be sufficient for the network device 102 to signal the terminal device 600 of indices or a bitmap indicating the PUCCH/PUSCH resources assigned to the terminal device 600 among the configured/preconfigured array of PUCCH resources.

In an exemplary embodiment, the one or more resources allocated by the network device 102 to the terminal device 600 may be indicated from the network device using one or more of the following signaling:
Radio Resource Control (RRC) signaling;
Medium Access Control (MAC) Control Element (CE); and
L1 signaling.

In an exemplary embodiment, the memory 630 may contain instructions executable by the processor 620 whereby the terminal device 600 may be further operative to use a Physical Uplink Shared Channel (PUSCH) resource of the UL grant as the configured resource.

In an exemplary embodiment, the terminal device 600 may use a PUSCH of the UL grant by:
mapping the HARQ acknowledgement on the PUSCH resource if there is neither any Medium Access Control (MAC) Service Data Unit (SDU) nor any MAC CE to be transmitted on the PUSCH resource; or
multiplexing the SL HARQ acknowledgement and a MAC SDU or a MAC CE on the PUSCH resource if there is such MAC SDU or MAC CE to be transmitted on the PUSCH resource.

In an exemplary embodiment, when the terminal device 600 has obtained a UL grant for a HARQ acknowledgement, it may be that the UL grant is not allowed to be skipped by the terminal device 600 regardless of whether the terminal device 600 is configured with or allowed to apply UL grant skipping. In other words, the terminal device 600 may build a MAC PDU containing only the SL HARQ acknowledgement and transmit the PDU on the PUSCH using the UL grant. Alternatively, whether to skip UL grant when the terminal device 600 has only the HARQ acknowledgement available for transmission may be configured to the terminal device 600 by the network device 102.

In an exemplary embodiment, the memory 630 may contain instructions executable by the processor 620 whereby the terminal device 600 may be further operative to generate the HARQ acknowledgment if no HARQ acknowledgement is received for a predefined period. As an example, after an SL transmission using an SL grant by the terminal device 600, it may be that the terminal device 600 cannot receive any HARQ acknowledgement from any receiving terminal device (there may be one or multiple receiving terminal devices depending on cast type) although HARQ feedback has been enabled for the SL transmission. The terminal device 600 may determine to generate an SL HARQ acknowledgement by itself and send to the network device 102. The terminal device 600 may generate a positive HARQ acknowledgment as the HARQ acknowledgment if no transmission resources for SL-U retransmission are required, and generate a negative HARQ acknowledgment as the HARQ acknowledgment if transmission resources for SL-U retransmission are required. In an example, the terminal device 600 may start a timer after the starting of the SL-U transmission, stop the timer when receiving the HARQ acknowledgment from the second terminal device, and generate the HARQ acknowledgment when the timer expires. The terminal device 600 may also restart the timer every time (when) the terminal device 600 has performed a retransmission. The timer expiring means that no HARQ acknowledgment is received from the second terminal device for a time period.

In an exemplary embodiment, the terminal device 600 may be configured with multi-connection with the network device 102, and the memory 630 may contain instructions executable by the processor 620 whereby the terminal device 600 may be further operative to use an available resource on a connection different from the connection on which the transmission resources are received as the configured resource. For example, in an example in which the terminal device 600 is configured with multi-connections (e.g., via carrier aggregation or dual connectivity) in the Uu interface, the memory 630 may contain instructions executable by the processor 620 whereby the terminal device 600 may be further operative to determine to use whatever available PUCCH resource or whatever available PUSCH resource in any other serving cell or carrier to transmit the SL HARQ acknowledgement.

In an exemplary embodiment, the memory 630 may contain instructions executable by the processor 620 whereby the terminal device 600 may be further operative to receive an SL-U transmission from the peer terminal device (for example, terminal device 104), and generate the HARQ acknowledgement associated with the SL-U transmission after the SL-U transmission finishes.

In an exemplary embodiment, the memory 630 may contain instructions executable by the processor 620 whereby the terminal device 600 may be further operative to perform an LBT operation for finding opportunities to transmit the HARQ acknowledgement, find an available SL resource if the LBT operation is successful but no Physical Sidelink Feedback Channel (PSFCH) resource is available within a given time period, and transmit the HARQ acknowledgement on the found available SL resource to the peer terminal device.

In an exemplary embodiment, the memory 630 may contain instructions executable by the processor 620 whereby the terminal device 600 may be further operative to find available SL resources for a Physical Sidelink Shared Channel (PSSCH) or Physical Sidelink Common Control Channel (PSCCH) transmission towards the peer terminal device within that time period, and then transmit the HARQ acknowledgement by multiplexing the HARQ acknowledgement in the PSSCH or PSCCH transmission towards the peer terminal device. For example, when the terminal device 600 has received an SL transmission on an unlicensed band, if the terminal device 600 is required to provide an SL HARQ acknowledgement to the transmitting terminal device, the terminal device 600 may perform LBT operation prior to the transmission of the SL HARQ acknowledgement. The terminal device 600 may be subject to LBT failures. This may delay transmission of the SL HARQ acknowledgement. If the terminal device 600 cannot find suitable PSFCH resources within a given time period (i.e., a maximum time period during which the terminal device 600 has to provide the SL HARQ acknowledgement), the terminal device 600 may choose to multiplex the SL HARQ acknowledgement in a PSSCH or PSCCH transmission towards the transmitting terminal device if the terminal device 600 can manage to find SL resources for the PSSCH or the PSCCH transmission within that time period. In this way, more transmission opportunities can be provided to the terminal device 600 for the SL HARQ acknowledgement.

In an exemplary embodiment, the memory 630 may contain instructions executable by the processor 620 whereby the terminal device 600 may be further operative to find available SL resources on a connection different from the connection on which the SL-U transmission is received, and transmit the HARQ acknowledgement on the available SL resources on the different connection. For example, the terminal device 600 may be configured with multi-connections (e.g., via carrier aggregation or dual connectivity) in the SL connections. In such a case, if there are multiple SL carriers available/configured between the terminal device 600 and the transmitting terminal device, and if an SL HARQ acknowledgement is subject to LBT failures on an SL carrier (e.g., SL carrier 1), the SL HARQ acknowledgement may be transmitted on another SL carrier (e.g., SL carrier 2).

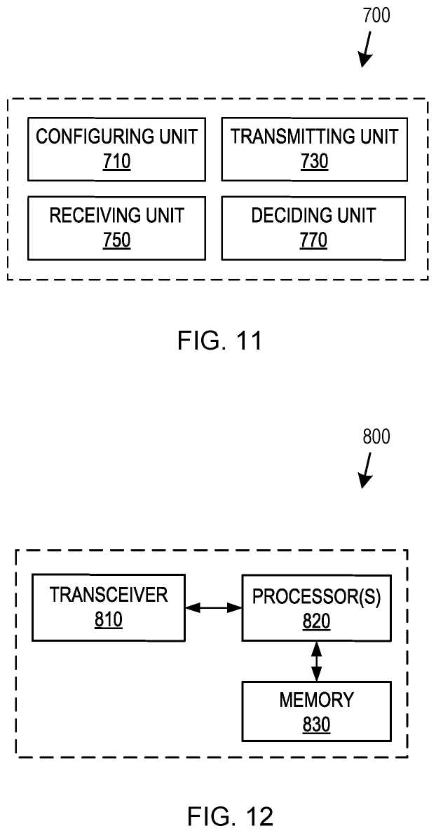

Correspondingly to the method 400 as described above, a network device is provided. FIG. 11 is a block diagram of a network device 700 according to an embodiment of the present disclosure.

As shown in FIG. 11, the network device 700 comprises (e.g. includes) a configuring unit 710 configured to configure transmission resources for SL-U transmission to a first terminal device 104 to perform the SL-U transmission, a transmitting unit 730 configured to transmit the transmission resources to the first terminal device 104. The configuring unit 710 is further configured to configure one or more resources for the HARQ acknowledgment associated with the SL-U transmission, and the transmitting unit 730 is further configured to transmit the configured resource to the first terminal device. The network device 700 further comprises (e.g. includes) a receiving unit 750 configured to receive the HARQ acknowledgment from the first terminal device. The configured resource is time compensated for LBT delays occurring during the SL-U transmission and/or during a transmission of the HARQ acknowledgement.

In an exemplary embodiment, the transmitting unit 730 may be configured to transmit the configured resource before transmitting the transmission resources; or upon transmitting the transmission resources; or after transmitting the transmission resources.

That is, the resource for the HARQ acknowledgement may be that pre-configured by the network device 700 to the first terminal device 104, or that configured by the network device 700 to the first terminal device 104 along with the SL grant for the SL-U transmission, or even that configured by the network device 700 to the first terminal device 104 when there is such a HARQ acknowledgement to be transmitted at the first terminal device 104.

In an exemplary embodiment, the receiving unit 750 may be configured to receive a request from the first terminal device, and the transmitting unit 730 may be configured to transmit one or more resources to the first terminal device 104. For example, since there may be LBT delays in transmitting the HARQ acknowledgement, the network device 700 may not pre-configure resources for transmitting the HARQ acknowledgement, and may configure the resource upon request from the first terminal device 104. The first terminal device 104 may request the network device 700 for resources to transmit the HARQ acknowledgement when there is a HARQ acknowledgement to be transmitted. As another example, the network device 700 may pre-configure or configure the resource for the HARQ acknowledgement along with the SL grant resources for transmitting the HARQ acknowledgement. The first terminal device 104, when getting ready to transmit the HARQ acknowledgement, may find that the pre-configured or configured resources are not available due to the LBT delays. The first terminal device 104 may request the network device 700 for resources to transmit the HARQ acknowledgement.

In an exemplary embodiment, the request is a Scheduling Request (SR) or a random access preamble for triggering a Random Access Channel (RACH) procedure. For example, the first terminal device 104 may trigger an SR for requesting PUSCH resources if there are not any (i.e. if there are no) resources available for transmitting the HARQ acknowledgement. A specific PUCCH SR resource/SR configuration may be configured to the first terminal device 104 for requesting PUSCH resources for the HARQ acknowledgement. Upon reception of the SR, the transmitting unit 730 of the network device 700 may assign a UL grant to the first terminal device 104. As another example, the first terminal device 104 may trigger a RACH procedure for requesting PUSCH resources if there are not any (i.e. if there are no) resources available for transmitting the HARQ acknowledgement. A specific RACH resource/RACH configuration may be configured to the first terminal device 104 for requesting PUSCH resources for the HARQ acknowledgement. Upon reception of the RACH, the transmitting unit 730 of the network device 700 may assign a UL grant to the first terminal device 104. The RACH resource may be a preamble, RO in frequency domain or time domain.

In an exemplary embodiment, the network device 700 may further include a deciding unit 770 configured to decide one of a PUCCH resource or a Physical Uplink Shared Channel (PUSCH) resource to be configured, and the configuring unit 710 is further configured to configure the decided resource to the first terminal device.

In an exemplary embodiment, the deciding unit 770 may be configured to decide one of a PUCCH resource or a PUSCH resource to be configured depending on one of the following conditions:
deciding to configure a PUSCH resource if there is no free PUCCH resource;
deciding to configure a PUCCH resource if there is no free PUSCH resource;
deciding to configure a PUCCH resource if there are both a free PUCCH resource and a free PUSCH resource and a high transmission reliability for the HARQ acknowledgement is required; and
deciding to configure a PUSCH resource if there are both a free PUCCH resource and a free PUSCH resource and the HARQ acknowledgement doesn't require a high transmission reliability.

In an exemplary embodiment, the configured resource may be one or more of, or a combination of, the following:
one or more PUCCH resources; and
one or more PUSCH resources.

In an exemplary embodiment, the network device 700 may (pre-)configure one or more resources for the first terminal device 104, and the one or more resources may be PUCCH or PUSCH resources.

In an exemplary embodiment, the configuring unit 710 may be configured to pre-configure a set of resources to the first terminal device, and the transmitting unit 730 may be further configured to transmit the configured resource by indicating resources to the first terminal device by indices of resources in the set of resources. For example, configuration (e.g. detailed configuration) of an array of PUCCH/PUSCH resources (e.g., locations in frequency domain and time domain) may be already configured to the first terminal device 104 by the network device 700 via RRC signaling (e.g., when the connection to the network device 700 is setup) or preconfigured to the first terminal device 104. Thus, when the network device 700 later signals an SL grant to the first terminal device 104 via Mode 1 resource allocation, it can be sufficient for the network device 700 to signal the first terminal device 104 of indices or a bitmap indicating the PUCCH/PUSCH resources assigned to the first terminal device 104 among the configured/preconfigured array of PUCCH/PUSCH resources.

In an exemplary embodiment, the transmitting unit 730 may be configured to transmit the configured resource using one or more of the following signaling:
Radio Resource Control (RRC) signaling;
Medium Access Control (MAC) Control Element (CE); and
L1 signaling.

In case of L1 signaling, new fields may be introduced in the DCI to indicate a set of PUCCH/PUSCH resources (i.e., more than 2 resources). Alternatively, existing fields in the DCI are repurposed to indicate a set of PUCCH/PUSCH resources. Accordingly, a new DCI format may be defined. In an example, new fields may be added to the DCI format 3_0 and/or the DCI format 3_1. The new fields may be PUCCH/PUSCH resource indicators.

In case of MAC CE based signaling, a new MAC CE may be defined. Alternatively, an existing MAC CE may be reused for indicating a set of PUCCH/PUSCH resources.

In case of RRC signaling, new information elements may be defined for indicating a set of PUCCH/PUSCH resources.

In order to limit the size of new fields, a bitmap field may be defined which contains multiple bits. For example, each bit may represent a PUCCH/PUSCH resource among the configured/preconfigured array of PUCCH/PUSCH resources. The bit with a value of ‘0’ can mean that the corresponding resource is not assigned to the first terminal device 104, while a value of ‘1’ can mean that the corresponding resource is assigned to the first terminal device 104.

In an exemplary embodiment, the transmitting unit 730 may be further configured to wait a configured time period before transmitting transmission resources for SL-U retransmission to the first terminal device if no HARQ acknowledgement for the SL-U transmission is received from the first terminal device at the configured resource. For example, when the network device 700 has assigned an SL grant on an unlicensed band to the first terminal device 104, if the network device 700 has also assigned a PUCCH resource to the first terminal device 104 for forwarding the SL HARQ acknowledgement, the network device 700 may not immediately schedule SL grants for retransmissions to the first terminal device 104 when the network device 700 is not able to receive/detect any transmission on the PUCCH resource. The network device 700 can wait a while (optionally, a configured time period) to see if the network device 700 may receive the expected SL HARQ acknowledgement on the subsequent PUSCH or PUCCH resource. In this way, the network device 700 can be avoided to assign unnecessary SL grants to the first terminal device 104, thereby reducing resource wastage.

The units 710-770 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 8.

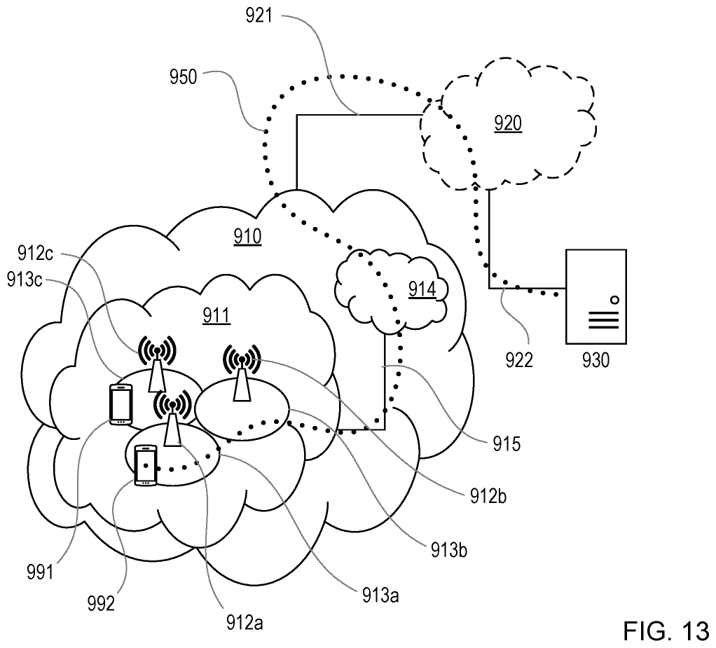

FIG. 12 is a block diagram of a network device 800 according to another embodiment of the present disclosure.

The network device 800 comprises (e.g. includes) a transceiver 810, a processor 820 and a memory 830. The memory 830 can contain instructions executable by the processor 820 whereby the network device 800 can be operative to perform the actions, e.g., of the procedure described earlier in conjunction with FIG. 8. Particularly, the memory 830 may contain instructions executable by the processor 820 whereby the network device 800 can be operative to facilitate Side Link (SL) transmission on an Unlicensed band (SL-U).

In an exemplary embodiment, the memory 830 may contain instructions executable by the processor 820 whereby the network device 800 may be further operative to configure transmission resources for SL-U transmission to a first terminal device 104 to perform the SL-U transmission, transmit the transmission resources to the first terminal device 104 via the transceiver 810, configure one or more resources for the HARQ acknowledgment associated with the SL-U transmission, transmit the configured resource to the first terminal device via the transceiver 810, and receive the HARQ acknowledgment from the first terminal device. The configured resource is time compensated for LBT delays occurring during the SL-U transmission and/or during a transmission of the HARQ acknowledgement.

In an exemplary embodiment, the memory 830 may contain instructions executable by the processor 820 whereby the transceiver 610 may be further operative to transmit the configured resource before transmitting the transmission resources; or upon transmitting the transmission resources; or after transmitting the transmission resources.

That is, the resource for the HARQ acknowledgement may be that pre-configured by the network device 800 to the first terminal device 104, or that configured by the network device 800 to the first terminal device 104 along with the SL grant for the SL-U transmission, or even that configured by the network device 800 to the first terminal device 104 when there is such a HARQ acknowledgement to be transmitted at the first terminal device 104.

In an exemplary embodiment, the memory 830 may contain instructions executable by the processor 820 whereby the transceiver 810 may be further operative to receive a request from the first terminal device, and transmit one or more resources to the first terminal device 104. For example, since there may be LBT delays in transmitting the HARQ acknowledgement, the network device 800 may not pre-configure resources for transmitting the HARQ acknowledgement, and may configure the resource upon request from the first terminal device 104. The first terminal device 104 may request the network device 800 for resources to transmit the HARQ acknowledgement when there is a HARQ acknowledgement to be transmitted. As another example, the network device 800 may pre-configure or configure the resource for the HARQ acknowledgement along with the SL grant resources for transmitting the HARQ acknowledgement. The first terminal device 104, when getting ready to transmit the HARQ acknowledgement, may find that the pre-configured or configured resources are not available due to the LBT delays. The first terminal device 104 may request the network device 800 for resources to transmit the HARQ acknowledgement.

In an exemplary embodiment, the request may be a Scheduling Request (SR) or a random access preamble for triggering a Random Access Channel (RACH) procedure. For example, the first terminal device 104 may trigger an SR for requesting PUSCH resources if there are not any (i.e. if there are no) resources available for transmitting the HARQ acknowledgement. A specific PUCCH SR resource/SR configuration may be configured to the first terminal device 104 for requesting PUSCH resources for the HARQ acknowledgement. Upon reception of the SR, the network device 800 may assign a UL grant to the first terminal device 104. As another example, the first terminal device 104 may trigger a RACH procedure for requesting PUSCH resources if there are not any (i.e. if there are no) resources available for transmitting the HARQ acknowledgement. A specific RACH resource/RACH configuration may be configured to the first terminal device 104 for requesting PUSCH resources for the HARQ acknowledgement. Upon reception of the RACH, the network device 800 may assign a UL grant to the first terminal device 104. The RACH resource may be a preamble, RO in frequency domain or time domain.

In an exemplary embodiment, the memory 830 may contain instructions executable by the processor 820 whereby the network device 800 may be further operative to decide one of a PUCCH resource or a Physical Uplink Shared Channel (PUSCH) resource to be configured, and configure the decided resource to the first terminal device.

In an exemplary embodiment, the memory 830 may contain instructions executable by the processor 820 whereby the network device 800 may be further operative to decide one of a PUCCH resource or a PUSCH resource to be configured depending one of the following conditions:
deciding to configure a PUSCH resource if there is no free PUCCH resource;
deciding to configure a PUCCH resource if there is no free PUSCH resource;
deciding to configure a PUCCH resource if there are both a free PUCCH resource and a free PUSCH resource and a high transmission reliability for the HARQ acknowledgement is required; and
deciding to configure a PUSCH resource if there are both a free PUCCH resource and a free PUSCH resource and the HARQ acknowledgement doesn't require a high transmission reliability.

In an exemplary embodiment, the configured resource may be one or more of, or a combination of, the following:
one or more PUCCH resources; and
one or more PUSCH resources.

In an exemplary embodiment, the network device 800 may (pre-)configure one or more resources for the first terminal device 104, and the one or more resources may be PUCCH or PUSCH resources.

In an exemplary embodiment, the memory 830 may contain instructions executable by the processor 820 whereby the network device 800 may be further operative to pre-configure a set of resources to the first terminal device, and transmit the configured resource by indicating resources to the first terminal device by indices of resources in the set of resources. For example, configuration (e.g. detailed configuration) of an array of PUCCH/PUSCH resources (e.g., locations in frequency domain and time domain) may be already configured to the first terminal device 104 by the network device 800 via RRC signaling (e.g., when the connection to the network device 700 is setup) or preconfigured to the first terminal device 104. Thus, when the network device 800 later signals an SL grant to the first terminal device 104 via Mode 1 resource allocation, it can be sufficient for the network device 800 to signal the first terminal device 104 of indices or a bitmap indicating the PUCCH/PUSCH resources assigned to the first terminal device 104 among the configured/preconfigured array of PUCCH/PUSCH resources.

In an exemplary embodiment, the memory 830 may contain instructions executable by the processor 820 whereby the transceiver 810 may be further operative to transmit the configured resource using one or more of the following signaling:
Radio Resource Control (RRC) signaling;
Medium Access Control (MAC) Control Element (CE); and
L1 signaling.

In case of L1 signaling, new fields may be introduced in the DCI to indicate a set of PUCCH/PUSCH resources (i.e., more than 2 resources). Alternatively, existing fields in the DCI may be repurposed to indicate a set of PUCCH/PUSCH resources. Accordingly, a new DCI format may be defined. In an example, new fields may be added to the DCI format 3_0 and/or the DCI format 3_1. The new fields may be PUCCH/PUSCH resource indicators.

In case of MAC CE based signaling, a new MAC CE may be defined. Alternatively, an existing MAC CE may be reused for indicating a set of PUCCH/PUSCH resources.

In case of RRC signaling, new information elements may be defined for indicating a set of PUCCH/PUSCH resources.

In order to limit the size of new fields, a bitmap field may be defined which contains multiple bits. For example, each bit may represent a PUCCH/PUSCH resource among the configured/preconfigured array of PUCCH/PUSCH resources. The bit with a value of ‘0’ can mean that the corresponding resource is not assigned to the first terminal device 104, while a value of ‘1’ can mean that the corresponding resource is assigned to the first terminal device 104.

In an exemplary embodiment, the memory 830 may contain instructions executable by the processor 820 whereby the transceiver 810 may be further operative to wait a configured time period before transmitting transmission resources for SL-U retransmission to the first terminal device if no HARQ acknowledgement for the SL-U transmission is received from the first terminal device at the configured resource. For example, when the network device 800 has assigned an SL grant on an unlicensed band to the first terminal device 104, if the network device 800 has also assigned a PUCCH resource to the first terminal device 104 for forwarding an SL HARQ acknowledgement, the network device 800 may not immediately schedule SL grants for retransmissions to the first terminal device 104 when the network device 800 is not able to receive/detect any transmission on the PUCCH resource. The network device 800 can wait a while (optionally, a configured time period) to see if the network device 800 may receive the expected SL HARQ acknowledgement on the subsequent PUSCH or PUCCH resource. In this way, the network device 800 can be avoided to assign unnecessary SL grants to the first terminal device 104, thereby reducing resource wastage.

The present disclosure also provides at least one computer program product, which may be in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program can include: code/computer readable instructions, which when executed by the processor 620 causes the terminal device 600 to perform the actions, e.g., of the procedure described earlier in conjunction with FIGS. 5-7; or code/computer readable instructions, which when executed by the processor 820 causes the network device 800 to perform the actions, e.g., of the procedure described earlier in conjunction with FIG. 8.

The computer program product may be configured as a computer program code structured in computer program modules. The computer program modules can essentially perform the actions of the flow illustrated in FIGS. 5-8.

The processor may be a single CPU (Central processing unit), but can also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-access memory (RAM), a Read-Only Memory (ROM), or an EEPROM, and the computer program modules described above can in alternative embodiments be distributed on different computer program products in the form of memories

With reference to FIG. 13, in accordance with an embodiment, a communication system includes a telecommunication network 910, such as a 3GPP-type cellular network, which comprises an access network 911, such as a radio access network, and a core network 914. The access network 911 comprises a plurality of network nodes 912a, 912b, 912c, such as NBs, eNBs, gNBs or other types of wireless access points, each defining a corresponding coverage area 913a, 913b, 913c. Each network node 912a, 912b, 912c is connectable to the core network 914 over a wired or wireless connection 915. A first user equipment (UE) 991 located in coverage area 913c is configured to wirelessly connect to, or be paged by, the corresponding network node 912c. A second UE 992 in coverage area 913a is wirelessly connectable to the corresponding network node 912a. While a plurality of UEs 991, 992 are illustrated in this example, the disclosed embodiments are equally applicable to a situation where a sole UE is in the coverage area or where a sole UE is connecting to the corresponding network node 912.

The telecommunication network 910 is itself connected to a host computer 930, which may be embodied in the hardware and/or software of a standalone server, a cloud-implemented server, a distributed server or as processing resources in a server farm. The host computer 930 may be under the ownership or control of a service provider, or may be operated by the service provider or on behalf of the service provider. The connections 921, 922 between the telecommunication network 910 and the host computer 930 may extend directly from the core network 914 to the host computer 930 or may go via an optional intermediate network 920. The intermediate network 920 may be one of, or a combination of more than one of, a public, private or hosted network; the intermediate network 920, if any, may be a backbone network or the Internet; in particular, the intermediate network 920 may comprise two or more sub-networks (not shown).

The communication system of FIG. 13 as a whole enables connectivity between one of the connected UEs 991, 992 and the host computer 930. The connectivity may be described as an over-the-top (OTT) connection 950. The host computer 930 and the connected UEs 991, 992 are configured to communicate data and/or signaling via the OTT connection 950, using the access network 911, the core network 914, any intermediate network 920 and possible further infrastructure (not shown) as intermediaries. The OTT connection 950 may be transparent in the sense that the participating communication devices through which the OTT connection 950 passes are unaware of routing of uplink and downlink communications. For example, a network node 912 may not or need not be informed about the past routing of an incoming downlink communication with data originating from a host computer 930 to be forwarded (e.g., handed over) to a connected UE 991. Similarly, the network node 912 need not be aware of the future routing of an outgoing uplink communication originating from the UE 991 towards the host computer 930.

The UE 992 is configured to include at least an interpretation unit (not shown) as previously described.

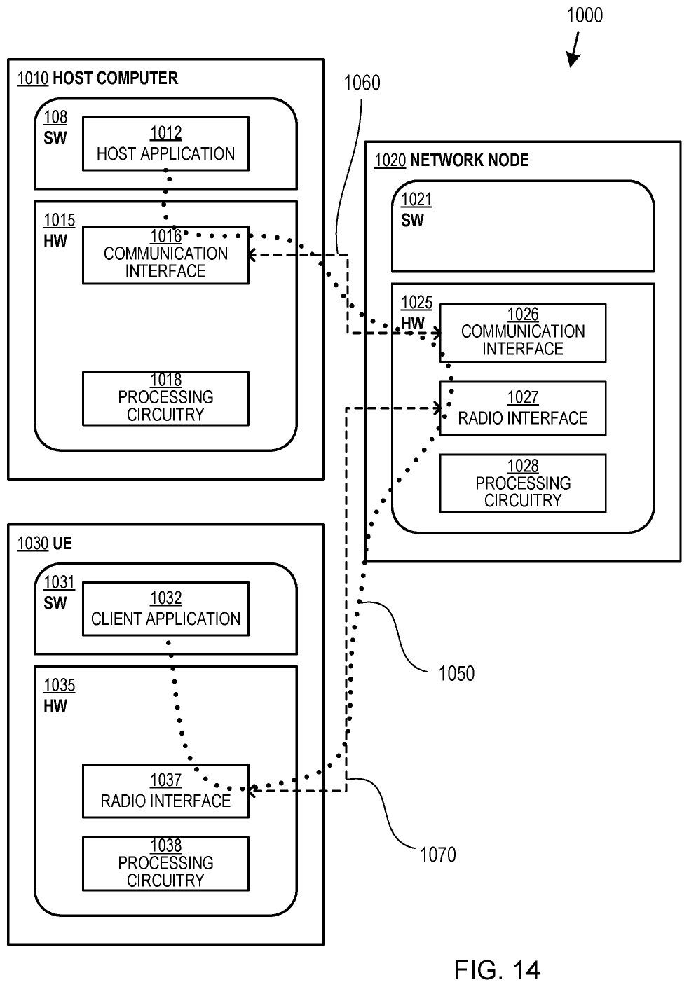

Example implementations, in accordance with an embodiment, of the UE, network node and host computer discussed in the preceding paragraphs will now be described with reference to FIG. 14. In a communication system 1000, a host computer 1010 comprises hardware 1015 including a communication interface 1016 configured to set up and maintain a wired or wireless connection with an interface of a different communication device of the communication system 1000. The host computer 1010 further comprises processing circuitry 1018, which may have storage and/or processing capabilities. In particular, the processing circuitry 1018 may comprise one or more programmable processors, application-specific integrated circuits, field programmable gate arrays or combinations of these (not shown) adapted to execute instructions. The host computer 1010 further comprises software 108, which is stored in or accessible by the host computer 1010 and executable by the processing circuitry 1018. The software 108 includes a host application 1012. The host application 1012 may be operable to provide a service to a remote user, such as a UE 1030 connecting via an OTT connection 1050 terminating at the UE 1030 and the host computer 1010. In providing the service to the remote user, the host application 1012 may provide user data which is transmitted using the OTT connection 1050.

The communication system 1000 further includes a network node 1020 provided in a telecommunication system and comprising hardware 1025 enabling it to communicate with the host computer 1010 and with the UE 1030. The hardware 1025 may include a communication interface 1026 for setting up and maintaining a wired or wireless connection with an interface of a different communication device of the communication system 1000, as well as a radio interface 1027 for setting up and maintaining at least a wireless connection 1070 with a UE 1030 located in a coverage area (not shown in FIG. 14) served by the network node 1020. The communication interface 1026 may be configured to facilitate a connection 1060 to the host computer 1010. The connection 1060 may be direct or it may pass through a core network (not shown in FIG. 14) of the telecommunication system and/or through one or more intermediate networks outside the telecommunication system. In the embodiment shown, the hardware 1025 of the network node 1020 further includes processing circuitry 1028, which may comprise one or more programmable processors, application-specific integrated circuits, field programmable gate arrays or combinations of these (not shown) adapted to execute instructions. The network node 1020 further has software 1021 stored internally or accessible via an external connection.

The communication system 1000 further includes the UE 1030 already referred to. The hardware 1035 of the UE 1030 may include a radio interface 1037 configured to set up and maintain a wireless connection 1070 with a network node serving a coverage area in which the UE 1030 is currently located. The hardware 1035 of the UE 1030 further includes processing circuitry 1038, which may comprise one or more programmable processors, application-specific integrated circuits, field programmable gate arrays or combinations of these (not shown) adapted to execute instructions. The UE 1030 further comprises software 1031, which is stored in or accessible by the UE 1030 and executable by the processing circuitry 1038. The software 1031 includes a client application 1032. The client application 1032 may be operable to provide a service to a human or non-human user via the UE 1030, with the support of the host computer 1010. In the host computer 1010, an executing host application 1012 may communicate with the executing client application 1032 via the OTT connection 1050 terminating at the UE 1030 and the host computer 1010. In providing the service to the user, the client application 1032 may receive request data from the host application 1012 and provide user data in response to the request data. The OTT connection 1050 may transfer both the request data and the user data. The client application 1032 may interact with the user to generate the user data that it provides.

It is noted that the host computer 1010, network node 1020 and UE 1030 illustrated in FIG. 14 may be identical to the host computer 1010, one of the network nodes 912a, 912b, 912c and one of the UEs 991, 992 of FIG. 13, respectively. This is to say, the inner workings of these entities may be as shown in FIG. 14 and independently, the surrounding network topology may be that of FIG. 13.

In FIG. 14, the OTT connection 1050 has been drawn abstractly to illustrate the communication between the host computer 1010 and the use equipment 1030 via the network node 1020, without explicit reference to any intermediary devices and the precise routing of messages via these devices. Network infrastructure may determine the routing, which it may be configured to hide from the UE 1030 or from the service provider operating the host computer 1010, or both. While the OTT connection 1050 is active, the network infrastructure may further take decisions by which it dynamically changes the routing (e.g., on the basis of load balancing consideration or reconfiguration of the network).

The wireless connection 1070 between the UE 1030 and the network node 1020 is in accordance with the teachings of the embodiments described throughout this disclosure. One or more of the various embodiments improve the performance of OTT services provided to the UE 1030 using the OTT connection 1050, in which the wireless connection 1070 forms the last segment. More precisely, the teachings of these embodiments may reduce PDCCH detection time and complexity and thereby provide benefits such as reduced user waiting time and reduced power consumption at the UE.

A measurement procedure may be provided for the purpose of monitoring data rate, latency and other factors on which the one or more embodiments improve. There may further be an optional network functionality for reconfiguring the OTT connection 1050 between the host computer 1010 and UE 1030, in response to variations in the measurement results. The measurement procedure and/or the network functionality for reconfiguring the OTT connection 1050 may be implemented in the software 108 of the host computer 1010 or in the software 1031 of the UE 1030, or both. In embodiments, sensors (not shown) may be deployed in or in association with communication devices through which the OTT connection 1050 passes; the sensors may participate in the measurement procedure by supplying values of the monitored quantities exemplified above, or supplying values of other physical quantities from which software 108, 1031 may compute or estimate the monitored quantities. The reconfiguring of the OTT connection 1050 may include message format, retransmission settings, preferred routing etc.; the reconfiguring need not affect the network node 1020, and it may be unknown or imperceptible to the network node 1020. Such procedures and functionalities may be known and practiced in the art. In certain embodiments, measurements may involve proprietary UE signaling facilitating the host computer's 1010 measurements of throughput, propagation times, latency and the like. The measurements may be implemented in that the software 108, 1031 causes messages to be transmitted, in particular empty or ‘dummy’ messages, using the OTT connection 1050 while it monitors propagation times, errors etc.

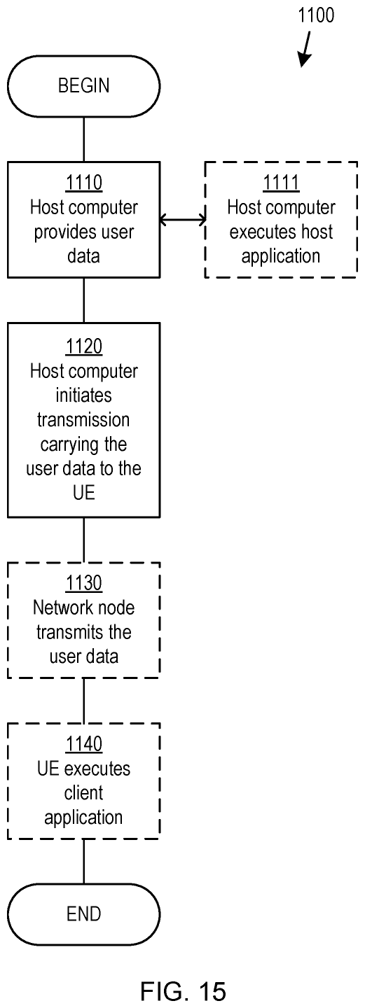

FIG. 15 is a flowchart illustrating a method 1100 implemented in a communication system, in accordance with one embodiment. The communication system includes a host computer, a network node and a UE which may be those described with reference to FIGS. 13 and 14. For simplicity of the present disclosure, only drawing references to FIG. 15 will be included in this section. In a first step 1110 of the method 1100, the host computer provides user data. In an optional substep 1111 of the first step 1110, the host computer provides the user data by executing a host application. In a second step 1120, the host computer initiates a transmission carrying the user data to the UE. In an optional third step 1130, the network node transmits to the UE the user data which was carried in the transmission that the host computer initiated, in accordance with the teachings of the embodiments described throughout this disclosure. In an optional fourth step 1140, the UE executes a client application associated with the host application executed by the host computer.

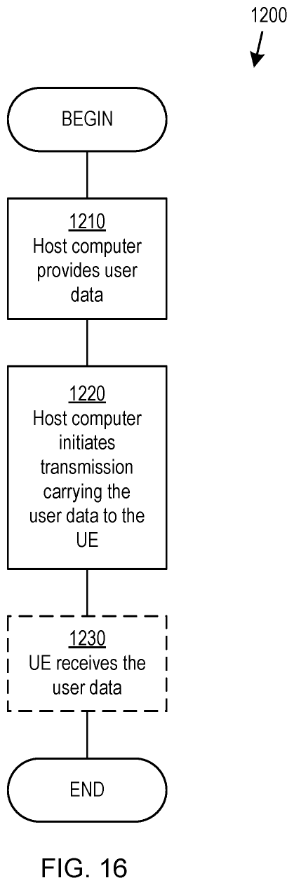

FIG. 16 is a flowchart illustrating a method 1200 implemented in a communication system, in accordance with one embodiment. The communication system includes a host computer, a network node and a UE which may be those described with reference to FIGS. 13 and 14. For simplicity of the present disclosure, only drawing references to FIG. 16 will be included in this section. In a first step 1210 of the method 1200, the host computer provides user data. In an optional substep (not shown) the host computer provides the user data by executing a host application. In a second step 1220, the host computer initiates a transmission carrying the user data to the UE. The transmission may pass via the network node, in accordance with the teachings of the embodiments described throughout this disclosure. In an optional third step 1230, the UE receives the user data carried in the transmission.

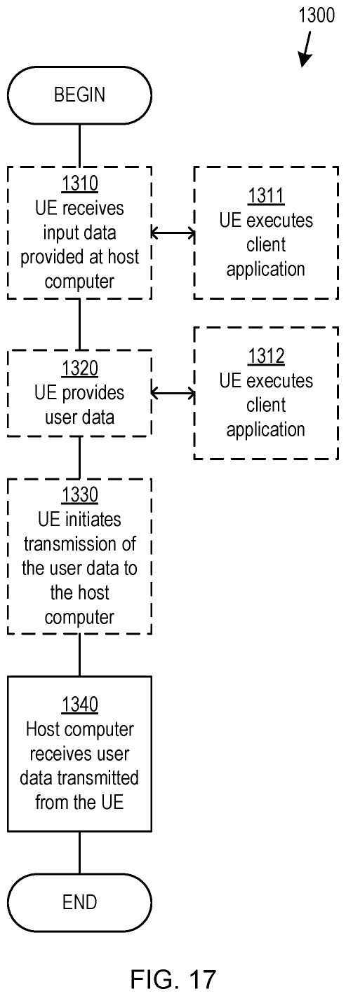

FIG. 17 is a flowchart illustrating a method 1300 implemented in a communication system, in accordance with one embodiment. The communication system includes a host computer, a network node and a UE which may be those described with reference to FIGS. 13 and 14. For simplicity of the present disclosure, only drawing references to FIG. 17 will be included in this section. In an optional first step 1310 of the method 1300, the UE receives input data provided by the host computer. Additionally or alternatively, in an optional second step 1320, the UE provides user data. In an optional substep 1312 of the second step 1320, the UE provides the user data by executing a client application. In a further optional substep 1311 of the first step 1310, the UE executes a client application which provides the user data in reaction to the received input data provided by the host computer. In providing the user data, the executed client application may further consider user input received from the user. Regardless of the specific manner in which the user data was provided, the UE initiates, in an optional third substep 1330, transmission of the user data to the host computer. In a fourth step 1340 of the method 1300, the host computer receives the user data transmitted from the UE, in accordance with the teachings of the embodiments described throughout this disclosure.

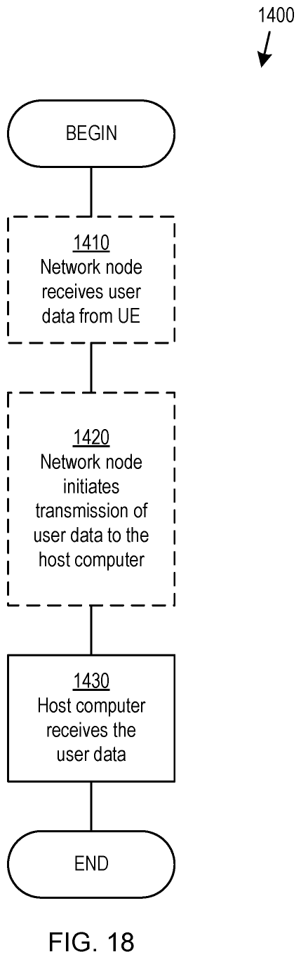

FIG. 18 is a flowchart illustrating a method 1400 implemented in a communication system, in accordance with one embodiment. The communication system includes a host computer, a network node and a UE which may be those described with reference to FIGS. 13 and 14. For simplicity of the present disclosure, only drawing references to FIG. 18 will be included in this section. In an optional first step 1410 of the method 1400, in accordance with the teachings of the embodiments described throughout this disclosure, the network node receives user data from the UE. In an optional second step 1420, the network node initiates transmission of the received user data to the host computer. In a third step 1430, the host computer receives the user data carried in the transmission initiated by the network node.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the present disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the present disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Other aspects of the present disclosure are defined in the following numbered statements:
Statement 1. A method (100) for Side Link (SL) transmission on an Unlicensed band (SL-U), performed by a first terminal device, comprising:
   receiving (S101) transmission resources for SL-U transmission allocated by a network device to the first terminal device,
   performing (S103) the SL-U transmission on the transmission resources to a second terminal device,
   obtaining (S105) HARQ acknowledgment associated with the SL-U transmission,
   configuring (S107) a resource for the HARQ acknowledgment, and
   transmitting (S109) the HARQ acknowledgement to the network device on the configured resource,
   wherein the configured resource is time compensated for Listen Before Talk (LBT) delays occurring during the SL-U transmission and/or during a transmission of the HARQ acknowledgement.
Statement 2. The method (100) of Statement 1, wherein configuring (S107) a resource for the HARQ acknowledgement comprises:
   configuring a resource for HARQ acknowledgement as one or more resources allocated by the network device to the first terminal device.
Statement 3. The method (100) of Statement 2, wherein the one or more resources allocated by the network device to the first terminal device comprise one or more of:
   one or more resources allocated by the network device to the first terminal device before receiving the transmission resources allocated to the first terminal device;
   one or more resources allocated by the network device to the first terminal device upon receiving the transmission resources allocated to the first terminal device; and
   one or more resources allocated by the network device to the first terminal device after receiving the transmission resources allocated to the first terminal device.
Statement 4. The method (100) of Statement 3, wherein the one or more resources allocated by the network device to the first terminal device after receiving the transmission resources allocated to the first terminal device is allocated by the network device in response to a request transmitted from the first terminal device to the network device.
Statement 5. The method (100) of any of Statements 2 to 4, wherein configuring (S107) a resource for the HARQ acknowledgement comprises one or more of:
   finding available resource in allocated resources for transmitting HARQ acknowledgement,
   in response to finding no available resource, transmitting a request to the network device, and
   receiving one or more resources allocated by the network device to the first terminal device in response to the request.
Statement 6. The method (100) of any of Statement 4 or 5, wherein the request is a Scheduling Request (SR) or a random access preamble for triggering a Random Access Channel (RACH) procedure.
Statement 7. The method (100) of any of Statements 2 to 6, wherein the configured resource is one or more or combination of the following:
   one or more PUCCH resources; and
   one or more PUSCH resources.
Statement 8. The method (100) of any of Statements 2 to 7, wherein the one or more resources allocated by the network device to the first terminal device are spread in the time domain.
Statement 9. The method (100) of any of Statements 2 to 8, wherein a set of resources are pre-configured from the network device to the first terminal device, and the one or more resources allocated by the network device to the first terminal device are indicated by indices of the one or more resources in the set of resources.
Statement 10. The method (100) of any of Statements 2 to 9, wherein the one or more resources allocated by the network device to the first terminal device are indicated from the network device using one of the following signaling:
   Radio Resource Control (RRC) signaling;
   Medium Access Control (MAC) Control Element (CE); and
   L1 signaling.
Statement 11. The method (100) of any of Statements 2 to 10, wherein configuring (S107) a resource for HARQ acknowledgement as one or more resources allocated by the network device to the first terminal device comprises:
   if an UL grant is available at the first terminal device, using a Physical Uplink Shared Channel (PUSCH) resource of the UL grant as the configured resource.
Statement 12. The method (100) of Statement 11, wherein using a PUSCH resource of the UL grant as the configured resource comprises:
   mapping the HARQ acknowledgement on the PUSCH resource if there is neither any Medium Access Control (MAC) Service Data Unit (SDU) nor any MAC CE to be transmitted on the PUSCH resource; or
   multiplexing the SL HARQ acknowledgement and a MAC SDU or a MAC CE on the PUSCH resource if there is such MAC SDU or MAC CE to be transmitted on the PUSCH resource.
Statement 13. The method (100) of any of Statements 1 to 12, wherein obtaining (S105) the HARQ acknowledgment associated with the SL-U transmission comprises:
   receiving the HARQ acknowledgment from the second terminal device.
Statement 14. The method (100) of any of Statements 1 to 13, wherein obtaining (S105) the HARQ acknowledgment associated with the SL-U transmission comprises:
   generating the HARQ acknowledgment if no HARQ acknowledgement is received for a predefined period.
Statement 15. The method (100) of Statement 14, wherein generating the HARQ acknowledgment comprises:
   generating a positive HARQ acknowledgment as the HARQ acknowledgment if no transmission resources for SL-U retransmission are required; and
   generating a negative HARQ acknowledgment as the HARQ acknowledgment if transmission resources for SL-U retransmission are required.
Statement 16. The method (100) of Statement 14 or 15, wherein generating the HARQ acknowledgment if no HARQ acknowledgement is received for a predefined period comprises:
   starting a timer after the starting of the SL-U transmission;
   stopping the timer when receiving the HARQ acknowledgment from the second terminal device; and
   generating the HARQ acknowledgment when the timer expires.
Statement 17. The method (100) of any of Statements 1 to 12, wherein the LBT delays comprise delays occurring due to LBT operations and/or LBT failures.
Statement 18. The method (100) of any of Statements 1 to 17, wherein the first terminal device is configured with multi-connection with the network device, and configuring a resource for the HARQ acknowledgment comprises:
   using an available resource on a connection different from the connection on which the transmission resources are received as the configured resource.
Statement 19. A method (300) for Side Link (SL) transmission on an Unlicensed band (SL-U), performed by a second terminal device, comprising:
   receiving (S301) an SL-U transmission from a first terminal device;
   generating (S303) HARQ acknowledgement associated with the SL-U transmission;
   performing (S305) an LBT operation;
   if the LBT operation is successful but no Physical Sidelink Feedback Channel (PSFCH) resource is available within a given time period, finding (S307) an available SL resource; and
   transmitting (S309) the HARQ acknowledgement on the found available SL resource to the first terminal device.
Statement 20. The method (300) of Statement 19, wherein finding (S307) an available SL resource comprises:
   finding available SL resources for a Physical Sidelink Shared Channel (PSSCH) or Physical Sidelink Common Control Channel (PSCCH) transmission towards the first terminal device within that time period; and
transmitting (S309) the HARQ acknowledgement on the found available SL resource comprises:
   transmitting the HARQ acknowledgement by multiplexing the HARQ acknowledgement in the PSSCH or PSCCH transmission towards the first terminal device.
Statement 21. The method (300) of Statement 19, wherein finding (S307) an available SL resources comprises:
   finding available SL resources on a connection different from the connection on which the SL-U transmission is received; and
transmitting (S309) the HARQ acknowledgement on the found available SL resource comprises:
   transmitting the HARQ acknowledgement on the available SL resources on the different connection.
Statement 22. A method (400) for Side Link (SL) transmission on an Unlicensed band (SL-U), performed by a network device, comprising:
   configuring and transmitting (S401) transmission resources for SL-U transmission to a first terminal device to perform the SL-U transmission,
   configuring (S403) one or more resources for HARQ acknowledgment associated with the SL-U transmission and transmitting the configured resource to the first terminal device, and
   receiving (S405) the HARQ acknowledgment from the first terminal device,
   wherein the configured resource is time compensated for Listen Before Talk (LBT) delays occurring during the SL-U transmission and/or during a transmission of the HARQ acknowledgement.
Statement 23. The method (400) of Statement 22, wherein transmitting the configured resource is performed before transmitting the transmission resources; or upon transmitting the transmission resources; or after transmitting the transmission resources.
Statement 24. The method (400) of Statement 22 or 23, wherein transmitting the configured resource comprises:
   receiving a request from the first terminal device; and
   allocating and transmitting one or more resources to the first terminal device.
Statement 25. The method (400) of Statement 24, wherein the request is a Scheduling Request (SR) or a random access preamble for triggering a Random Access Channel (RACH) procedure.
Statement 26. The method (400) of any of Statements 22 to 25, wherein configuring one or more resources for HARQ acknowledgment associated with the SL-U transmission and transmitting the configured resource to the first terminal device comprises:
   deciding one of a PUCCH resource or a Physical Uplink Shared Channel (PUSCH) resource to be configured; and
   configuring the decided resource to the first terminal device.
Statement 27. The method (400) of Statement 26, wherein deciding one of a PUCCH resource or a PUSCH resource to be configured comprises deciding one of a PUCCH resource or a PUSCH resource depending one of the following conditions:
   deciding to configure a PUSCH resource if there is no free PUCCH resource;
   deciding to configure a PUCCH resource if there is no free PUSCH resources;
   deciding to configure a PUCCH resource if there are both a free PUCCH resource and a free PUSCH resource and a high transmission reliability for the HARQ acknowledgement is required; and
   deciding to configure a PUSCH resource if there are both a free PUCCH resource and a free PUSCH resource and the HARQ acknowledgement doesn't require a high transmission reliability.
Statement 28. The method (400) of any of Statements 22 to 27, wherein the configured resource is one or more or combination of the following:
   one or more PUCCH resources; and
   one or more PUSCH resources.
Statement 29. The method (400) of any of Statements 22 to 28, wherein configuring one or more resources for HARQ acknowledgment associated with the SL-U transmission and transmitting the configured resource to the first terminal device comprises:
   pre-configuring a set of resources to the first terminal device, and
   transmitting the configured resource by indicating the one or more resources to the first terminal device by indices of the one or more resources in the set of resources.
Statement 30. The method (400) of any of Statements 22 to 29, wherein transmitting the configured resource to the first terminal device comprises:
   transmitting the configured resource using one of the following signaling:
   Radio Resource Control (RRC) signaling;
   Medium Access Control (MAC) Control Element (CE); and
   L1 signaling.
Statement 31. The method (400) of any of Statements 22 to 30, wherein the LBT delays comprise delays occurring due to LBT operations and/or LBT failures.
Statement 32. The method (400) of any of Statements 22 to 31, further comprising: waiting (S407) a configured time period before transmitting transmission resources for SL-U retransmission to the first terminal device if no HARQ acknowledgement for the SL-U transmission is received from the first terminal device at the configured resource.
Statement 33. A terminal device (600), comprising a transceiver (610), a processor (620) and a memory (630), the memory (630) comprising instructions executable by the processor (620) whereby the terminal device is operative to perform the method according to any of Statements 1-21.
Statement 34. A computer readable storage medium having computer program instructions stored thereon, the computer program instructions, when executed by a processor in a terminal device, causing the terminal device to perform the method according to any of Statements 1-21.
Statement 35. A network device (800), comprising a transceiver (810), a processor (820) and a memory (830), the memory (830) comprising instructions executable by the processor (820) whereby the network device is operative to perform the method according to any of Statements 22-32.
Statement 36. A computer readable storage medium having computer program instructions stored thereon, the computer program instructions, when executed by a processor in a network device, causing the network device to perform the method according to any of Statements 22-32.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

1-28. (canceled)

29. A method for side link transmission on an unlicensed band (SL-U transmission), performed by a first terminal device, the method comprising:
receiving transmission resources for SL-U transmission allocated by a network device to the first terminal device,
performing the SL-U transmission on the transmission resources to a second terminal device,
obtaining a Hybrid Automatic Repeat Request (HARQ) acknowledgment associated with the SL-U transmission,
configuring a resource for the HARQ acknowledgment, and
transmitting the HARQ acknowledgement to the network device on the configured resource,
wherein the configured resource is time compensated for Listen Before Talk (LBT) delays occurring during the SL-U transmission and/or during a transmission of the HARQ acknowledgement.

30. The method of claim 29, wherein configuring a resource for the HARQ acknowledgement comprises configuring a resource for the HARQ acknowledgement as one or more resources allocated by the network device to the first terminal device.

31. The method of claim 30, wherein the one or more resources allocated by the network device to the first terminal device comprise one or more of:
one or more resources allocated by the network device to the first terminal device before receiving the transmission resources allocated to the first terminal device;
one or more resources allocated by the network device to the first terminal device upon receiving the transmission resources allocated to the first terminal device; and
one or more resources allocated by the network device to the first terminal device after receiving the transmission resources allocated to the first terminal device.

32. The method of claim 31, wherein the one or more resources allocated by the network device to the first terminal device after receiving the transmission resources allocated to the first terminal device are allocated by the network device in response to a request transmitted from the first terminal device to the network device.

33. The method of claim 30, wherein configuring a resource for the HARQ acknowledgement comprises one or more of:
finding an available resource in allocated resources for transmitting the HARQ acknowledgement,
in response to finding no available resource, transmitting a request to the network device, and
receiving one or more resources allocated by the network device to the first terminal device in response to the request.

34. The method of claim 32, wherein the request is a Scheduling Request (SR) or a random access preamble for triggering a Random Access Channel (RACH) procedure.

35. The method of claim 30, wherein the configured resource is one or more of, or a combination of, the following:
one or more Physical Uplink Control Channel (PUCCH) resources; and
one or more Physical Uplink Shared Channel (PUSCH) resources.

36. The method of claim 30, wherein:
the one or more resources allocated by the network device to the first terminal device comprise resources that are spread in the time domain; and/or
a set of resources are pre-configured from the network device to the first terminal device, and the one or more resources allocated by the network device to the first terminal device comprise resources that are indicated by indices of resources in the set of resources; and/or
the one or more resources allocated by the network device to the first terminal device are indicated from the network device using one of the following signaling:
Radio Resource Control (RRC) signaling;
Medium Access Control Control Element (MAC CE); and
L1 signaling.

37. The method of claim 30, wherein configuring a resource for the HARQ acknowledgement as one or more resources allocated by the network device to the first terminal device comprises:
if an Uplink (UL) grant is available at the first terminal device, using a Physical Uplink Shared Channel (PUSCH) resource of the UL grant as the configured resource.

38. The method of claim 37, wherein using a PUSCH resource of the UL grant as the configured resource comprises:
mapping the HARQ acknowledgement on the PUSCH resource if there is neither any Medium Access Control Service Data Unit (MAC SDU) nor any MAC Control Element (MAC CE) to be transmitted on the PUSCH resource; or
multiplexing the SL HARQ acknowledgement and a MAC SDU or a MAC CE on the PUSCH resource if there is such MAC SDU or MAC CE to be transmitted on the PUSCH resource.

39. The method of claim 29, wherein obtaining the HARQ acknowledgment associated with the SL-U transmission comprises:
receiving the HARQ acknowledgment from the second terminal device; and/or
generating the HARQ acknowledgment if no HARQ acknowledgement is received for a predefined period.

40. The method of claim 39, wherein:
generating the HARQ acknowledgment comprises:
generating a positive HARQ acknowledgment as the HARQ acknowledgment if no transmission resources for SL-U retransmission are required; and
generating a negative HARQ acknowledgment as the HARQ acknowledgment if transmission resources for SL-U retransmission are required; and/or
generating the HARQ acknowledgment if no HARQ acknowledgement is received for a predefined period comprises:
starting a timer after the starting of the SL-U transmission;
stopping the timer when receiving the HARQ acknowledgment from the second terminal device; and
generating the HARQ acknowledgment when the timer expires.

41. The method of claim 29, wherein the LBT delays comprise delays occurring due to LBT operations and/or LBT failures.

42. A method for side link transmission on an unlicensed band (SL-U transmission), performed by a second terminal device, the method comprising:
receiving an SL-U transmission from a first terminal device;
generating a Hybrid Automatic Repeat Request (HARQ) acknowledgement associated with the SL-U transmission;
performing a Listen Before Talk (LBT) operation;
if the LBT operation is successful but no Physical Sidelink Feedback Channel (PSFCH) resource is available within a given time period, finding an available side link (SL) resource; and
transmitting the HARQ acknowledgement on the found available SL resource to the first terminal device.

43. The method of claim 42, wherein
finding an available SL resource comprises:
finding available SL resources for a Physical Sidelink Shared Channel (PSSCH) or Physical Sidelink Common Control Channel (PSCCH) transmission towards the first terminal device within that time period; and
transmitting the HARQ acknowledgement on the found available SL resource comprises:
transmitting the HARQ acknowledgement by multiplexing the HARQ acknowledgement in the PSSCH or PSCCH transmission towards the first terminal device.

44. A method for side link transmission on an unlicensed band (SL-U transmission), performed by a network device, the method comprising:
configuring and transmitting transmission resources for SL-U transmission to a first terminal device to perform the SL-U transmission,
configuring one or more resources for a Hybrid Automatic Repeat Request (HARQ) acknowledgment associated with the SL-U transmission and transmitting the configured resource to the first terminal device, and
receiving the HARQ acknowledgment from the first terminal device,
wherein the configured resource is time compensated for Listen Before Talk (LBT) delays occurring during the SL-U transmission and/or during a transmission of the HARQ acknowledgement.

45. The method of claim 44, wherein:
transmitting the configured resource is performed before transmitting the transmission resources, or upon transmitting the transmission resources, or after transmitting the transmission resources; and/or
transmitting the configured resource comprises:
receiving a request from the first terminal device; and
allocating and transmitting one or more resources to the first terminal device.

46. The method of claim 45, wherein the request is a Scheduling Request (SR) or a random access preamble for triggering a Random Access Channel (RACH) procedure.

47. The method of claim 44, wherein configuring one or more resources for the HARQ acknowledgment associated with the SL-U transmission and transmitting the configured resource to the first terminal device comprises:
deciding one of a Physical Uplink Control Channel (PUCCH) resource or a Physical Uplink Shared Channel (PUSCH) resource to be configured; and
configuring the decided resource to the first terminal device.

48. The method of claim 44, wherein the configured resource is one or more of, or a combination of, the following:
one or more Physical Uplink Control Channel (PUCCH) resources; and
one or more Physical Uplink Shared Channel (PUSCH) resources.

49. The method of claim 44, wherein configuring one or more resources for the HARQ acknowledgment associated with the SL-U transmission and transmitting the configured resource to the first terminal device comprises:
pre-configuring a set of resources to the first terminal device, and
transmitting the configured resource by indicating resources to the first terminal device by indices of resources in the set of resources.

50. The method of claim 44, wherein transmitting the configured resource to the first terminal device comprises:
transmitting the configured resource using one of the following signaling:
Radio Resource Control (RRC) signaling;
a Medium Access Control Control Element (MAC CE); and
L1 signaling.

51. The method of claim 44, wherein the LBT delays comprise delays occurring due to LBT operations and/or LBT failures.

52. The method of claim 44, further comprising:
waiting a configured time period before transmitting transmission resources for retransmission of the SL-U transmission to the first terminal device if no HARQ acknowledgement for the SL-U transmission is received from the first terminal device at the configured resource.

53. A terminal device, comprising a transceiver, a processor and a memory, the memory comprising instructions executable by the processor whereby the terminal device is operative to perform a method for side link transmission on an unlicensed band (SL-U transmission), the method comprising:
receiving transmission resources for SL-U transmission allocated by a network device to the terminal device,
performing the SL-U transmission on the transmission resources to a second terminal device,
obtaining a Hybrid Automatic Repeat Request (HARQ) acknowledgment associated with the SL-U transmission,
configuring a resource for the HARQ acknowledgment, and
transmitting the HARQ acknowledgement to the network device on the configured resource, wherein the configured resource is time compensated for Listen Before Talk (LBT) delays occurring during the SL-U transmission and/or during a transmission of the HARQ acknowledgement.

54. A network device, comprising a transceiver, a processor and a memory, the memory comprising instructions executable by the processor whereby the network device is operative to perform a method for side link transmission on an unlicensed band (SL-U transmission), the method comprising:
configuring and transmitting transmission resources for SL-U transmission to a first terminal device to perform the SL-U transmission,
configuring one or more resources for a Hybrid Automatic Repeat Request (HARQ) acknowledgment associated with the SL-U transmission and transmitting the configured resource to the first terminal device, and
receiving the HARQ acknowledgment from the first terminal device, wherein the configured resource is time compensated for Listen Before Talk (LBT) delays occurring during the SL-U transmission and/or during a transmission of the HARQ acknowledgement.
